(19) United States
(12) Patent Application Publication
(10) Pub. No.: US 2016/0140627 A1
(43) Pub. Date: May 19, 2016

(54) GENERATING HIGH QUALITY LEADS FOR MARKETING CAMPAIGNS

(71) Applicant: Adobe Systems Incorporated, San Jose, CA (US)

(72) Inventors: Stéphane Moreau, L'Hay Les Roses (FR); Ashish Duggal, Dehli (IN); Sachin Soni, New Delhi (IN); Anmol Dhawan, Ghaziabad (IN)

(73) Assignee: Adobe Systems Incorporated

(21) Appl. No.: 14/541,334

(22) Filed: Nov. 14, 2014

(51) Int. Cl. G06Q 30/02

(52) U.S. Cl. CPC G06Q 30/0282; G06Q 30/0203

(57) ABSTRACT

Systems and methods for generating high quality leads for marketing campaigns are disclosed. One disclosed method assigns scores to users in order to facilitate selection of which users will receive electronic marketing communications. The method includes identifying, by a marketing system, a target product for the marketing campaign. The method further includes collecting, by a sentiment engine configured to determine sentiments of referral sources, a referral context and a degree of sentiment from a referral source referring a user to a web page associated with the product. The method also includes determining time spent by the user on the web page and the user's interactions with the web page, and then assigning a score to the user based at least in part on the time spent by the user on the web page and the user's interactions with the web page.

### TECHNICAL FIELD

The present disclosure generally relates to evaluating leads for marketing campaigns, and more specifically relates to systems and methods for generating high quality leads by scoring leads based on one or more of a referral context, a referrer's perception towards a marketer's product, and user interactions with a marketer's web site.

### BACKGROUND

Companies and other organizations seek to market their products and services to consumers as effectively as they can. For example, to market a camera product, a company may identify a group of consumers that are amateur photographers by obtaining information from a photography club or from students in a photography course at a university. The company can then create marketing materials describing its new camera product that are targeted to consumers such as amateur photographers and send those materials to the identified group of consumers (e.g., leads). However, in some cases, it can be difficult to determine which consumers may be interested in a product, which consumers are qualified to purchase the product, and then, which features of the product should be emphasized or deemphasized for qualified consumers. In addition, consumers' qualifications to purchase product, consumers' interests in a particular product, or consumers' interests in features of the product, may change over time, which may affect the effectiveness of previously-created marketing materials. Thus, it may be difficult to plan and execute a marketing campaign without knowing current consumer sentiment about a product and without being able to update marketing materials as consumer sentiment changes over time.

Marketers and salespeople do not want to spend time on contacts that are not ready or are not qualified to make purchases (or purchase decisions). Thus, there is a need for systems that provide more qualified leads to marketers. Existing techniques for generating leads are limited because these techniques generate leads on the basis of static, ‘dumb’ rules without taking into account intelligence related to real time information about the context, sentiment and interaction that a lead has in relation to the marketer's product and services.

### SUMMARY

Systems and methods are disclosed for generating leads (e.g., prospects and potential customers) for marketing campaigns. Embodiments generate consumer interest in a product by identifying which customers should be targeted by a marketing campaign for the product.

One disclosed method assigns scores to users in order to facilitate selection of which users will receive electronic marketing communications. The method includes identifying, by a marketing system, a target product for the marketing campaign. The method further includes collecting, by a sentiment engine configured to determine sentiments of referral sources, a referral context and a degree of sentiment from a referral source referring a user to a web page associated with the product. The method also includes determining time spent by the user on the web page and the user's interactions with the web page, and then assigning a score to the user based at least in part on the time spent by the user on the web page and the user's interactions with the web page.

These illustrative embodiments are mentioned not to limit or define the invention, but rather to provide an example to aid understanding thereof. Illustrative embodiments are discussed in the Detailed Description, which provides further description of the invention. Advantages offered by various embodiments of this invention may be further understood by examining this specification.

### BRIEF DESCRIPTION OF THE FIGURES

These and other features, aspects, and advantages of the present disclosure are better understood when the following Detailed Description is read with reference to the accompanying drawings, where:

FIGS. 1 and 2 show systems for generating quality leads for marketing campaigns, in accordance with embodiments;

FIGS. 3A-C show systems for generating high quality leads for marketing campaigns, in accordance with embodiments according to certain exemplary embodiments;

FIG. 4 shows a method for generating high quality leads for marketing campaigns, in accordance with embodiments;

FIG. 5 shows keyword-level sentiment for an example search result, in accordance with embodiments;

FIG. 6 shows sentiment analysis from a sentiment engine for an example post, in accordance with embodiments;

FIG. 7 shows sentiment included in an example search result, in accordance with embodiments;

FIG. 8 shows results of text extraction and other data from an example product page, in accordance with embodiments;

FIG. 9 shows extracted entities, themes, an sentiment from an example product page, in accordance with embodiments;

FIGS. 10A-C show process flows for generating electronic marketing communications according to certain exemplary embodiments; and

FIG. 11 is a diagram of an exemplary computer system in which embodiments of the present disclosure can be implemented.

### DETAILED DESCRIPTION

Example embodiments are described herein in the context of systems and methods for generating high quality leads for marketing campaigns. Lead generation is the process of generation of consumer interest or inquiry into products or services of a business. Embodiments solve problems with traditional marketing tools that do not take into account the context of how a user arrives at a marketer's web site. By employing the disclosed techniques that consider the context of how a user arrived at a site and the sentiment at a page that referred the user to the site (e.g., a referring page), a marketer can avoid wasting time and resources on users who are unlikely to be customers. For example, a user can be scored as an unlikely customer (e.g., a ‘cold lead’) if the user has read negative reviews regarding the marketer's product at a referring page.

An embodiment assigns a score to a user (e.g., a lead) to indicate the potential of that user becoming a customer. Leads can be scored based on their interactions with marketing information associated with a product. For example, a user's interactions with a marketer's site and communications (e.g., emails) can contribute to a score. In some embodiments, an electronic marketing communication such as, for example, a targeted email, is sent to a user based on the score assigned to the user. Web tracking can be performed to collect information on the user's visit(s) to the marketer's site and to assign points to the user's score based on the user's interactions with the marketer's site. In embodiments, web tracking assigns a score to the user's activities. The scoring can take into account the context of how a user came to the marketer's site and the sentiment at a source page that referred the user the site.

According to an embodiment, a sentiment of a page that referred the user to the marketer's site (e.g., a source/referring page) can contribute to the score. For example, if there is a positive sentiment about a product at a referring page, a user arriving at the marker's page from that referring page can be assigned higher score to indicate that there is a greater chance that this user is a good prospect. In this example, if a source or referring page includes a positive review or posting for the product, a user arriving at the marketer's page from that referring page can be considered a good prospect for being converted to a purchaser (e.g., a ‘hot lead’). Conversely, if sentiment about the product at the referring page is negative, the user will have a lower score to indicate that there is a lower chance of converting the user to a purchaser/customer. In this way, a user can be scored as a prospect based on the context of how the user came to the marketer's site.

A user's score can be used as an indication of how good of a prospect the user is for buying the marketer's product. That is, the score can indicate how good of a candidate the user is for becoming a customer. Based on the score, an embodiment can determine if a follow up, targeted marketing communication (e.g., a targeted email) should be sent to the user. In one embodiment, a marketer sends an electronic marketing communication to a user based on the user's score exceeding a threshold. In an example where the electronic marketing communication is an email, email tracking can be used to collect information when the user open the email, and when the user clicks on a link provided in the email in order to navigate to the marketer's site. The collected information can indicate how relevant the user's interactions with the site are. For example, an embodiment can assign a higher score to a user that opens a link from the email and then interacts with the site to review specifications of the product being marketed as compared to another user that navigates to a page on the site that is unrelated to the product. In this way, embodiments avoid issues with marketing systems that merely assign the same score to both of such users based on them selecting the link in the email, without taking into account their very different interactions with the marketer's site after arriving at the site.

In one embodiment, a method, identifies, based on a referral context and a degree of sentiment, specific product features that should be emphasized to a user. This embodiment can use the referral context and the degree of sentiment to identify product features that the prospect should be targeted for. This targeting can be performed by referring the user to a nurturing program in order to nurture interest in the product and the specific features. For example, a marketing communication (e.g., a targeted email) can be sent to a user based on a score assigned to the user. In this way, an assigned score can be used to determine which leads or prospects to refer to the nurturing program and which leads to send marketing communications to. In an additional or alternative embodiment, a method identifies, for the given prospect, other products for which he can be a potential prospect (lead), and refers the user to the nurturing program for the corresponding products.

Exemplary methods can use web tracking scoring rules and email tracking scoring rules that take into account a referral source context and a user's interactions with a web page in order to assign a score to the user. Based on the score, the user can be categorized as a cold, warm, or hot lead. The score can also be used to determine if the user should be referred to a nurturing program that will emphasize specified product features, or other products, to the user.

According to embodiments, leads can be generated for at least two types of campaigns: acquisition campaigns; and nurturing campaigns. Each of these campaign types are described below.

Acquisition campaigns enable marketers to find new leads. Online Acquisition campaigns can include banner and direct response advertising on search engines and other websites. For example, when a user clicks on banner and direct response advertisements (e.g., ads), they can be taken to a form, where they can fill in their basic details to show their interest in the marketer's product or services.

Online acquisition campaigns can also include Social Media Ads and Promoted posts. With the rapid growth of social networking websites like Facebook®, Twitter®, Instagram®, Snapchat®, Google+® etc., social media is extensively used by organizations and individuals to generate leads.

Nurturing campaigns increase a marketer's knowledge of customers and prospects to better target the customers' expectations and needs. For example, a targeted marketing communication such as an email can be sent to a prospect who earlier registered on marketer's site via an online acquisition campaign. If the prospect opens this email and clicks on the link to visit the marketer's website again, this indicates that the prospect has a keen interest in the marketer's product or services.

An embodiment allows a marketer set up and automate data collection via Acquisition Campaigns and Nurturing Campaigns. A marketer can then create scoring rules and assign scores to various actions (activities) done by prospects. Based on the scores, leads can be rated as cold, warm, or hot. In an example, hot leads are prospects that can be routed to the marketer's sales department. Also, for example, cold leads are leads that the marketer may not be interested in because their score indicates that there is a high chance that these prospects will not be converted into purchasers or customers. Further, for example, warm leads are medium-level prospects that may be routed to a nurturing program so that more information is sent to the prospects in order to increase their interest in a product. Based on the results of the nurturing program, hot, high quality leads can be generated from warm leads. That is, if the nurturing program is successful in increasing a warm lead's interest in a product, or specified features of a product, that prospect can be assigned a higher score and re-categorized as a hot lead. Otherwise, the score remains unchanged and the marketer may not spend additional time and effort on the prospect. To assign scores, an example embodiment uses both explicit (event attendance, newsletter subscription, document download on a website) and implicit (number of visits to a website etc.) data. Example scenarios after an Acquisition Campaign include the following:

(1) Prospects with high scores—are categorized or marked as ‘Hot Leads’ and their information is forwarded to sales people to follow up with them.

(2) Prospects with medium scores—are marked as ‘Warm Leads’ and their information is sent to a ‘nurturing program.’ Based on their participation in the nurturing program, the prospects can be marked or categorized as ‘Hot’ or ‘Cold.’ For example, warm leads can be put into the nurturing program, and then categorized as either hot or cold, and their scores can be adjusted based on an email being opened and links within the email being opened/navigated to. Scores assigned based on user activity for emails sent over time.

(3) Prospects with Low scores—are marked as ‘Cold Leads’ and their information is not forwarded to sales department and neither they are a part of the nurturing program.

An embodiment uses a module aimed at business-to-business (B2B) customers and the module can be configured to build rules that qualifies leads based on user activity (e.g., opening an email, visiting a website, submitting a form to download info re: a product). This is scoring based on user activity and demographics (e.g., is user a Vice President/decision maker for purchases by an organization or business or is the user a regular user/non-decision maker).

Hence, in an embodiment, B2B software can be used to weed out unqualified leads, scores and ranks leads, routes hot leads to sales via real-time integration with Customer relationship management (CRM)/sales force automation (SFA), and automatically nurture other potential contacts to help move them along toward conversion (e.g., to a sale).

Embodiments implement the following capabilities for generating qualified leads. Leads can be scored based at least in part on web tracking and gauging/measuring the sentiment of a referrer site. For example, consider a visit from a referring LinkedIn® page versus a visit from a referring Facebook® page. According to this example, a higher score can be assigned to the LinkedIn® user based on context and sentiment at its source/referring page as compared to context and sentiment at the referring Facebook® page.

Embodiments can perform web tracking to collect information on Internet users (e.g., prospects and potential leads) that visit a marketer's website. Web tracking type scoring rules can be defined to enable marketers to assign points on the pages a lead visits. For example, an embodiment allows a marketer to create a rule which assigns 10 points to all Internet users who visit a page on the marketer's website.

However, this rule may result in the same score being assigned to all users coming to the site but that might not generate the best quality leads. This is because some of the leads might have read a lot about the product at the source/referring page and therefore have context about the product. Further, if the sentiment about the product is positive at the source/referring page, there is a great chance that this prospect may convert. Now, compare this to a prospect that just came to the site without having any context. In this example, the former should be assigned a higher score for coming to the site. Therefore, there is a need for methods and systems that take the context and the sentiment at the source/referring page in assigning the scores for activities to generate high quality leads

Embodiments can perform email tracking to collect information when users open the email and when they click on a link in the email. An email tracking type scoring rule enables a marketer to assign points when a user opens a targeted email or when the user clicks on the link in the email. For example, a marketer can create a rule which assigns 20 points to a user if he/she clicks on the link provided in the email. As used herein, the term “email tracking” generally refers to tracking and scoring user interactions with a variety of electronic marketing communications. That is, the email tracking techniques described herein are not limited to email communications and can be performed for other types of marketing communications, such as, but not limited to, text messages, social media communications, and other forms of communication.

However, on opening the link, user's interactions may or may not be relevant to the product. For example, after opening a link associated with a specific product or service (e.g., a Samsung™ Galaxy Note 3 smartphone), where the link is in an email, one user carefully read the specifications of the product or service whereas another user quickly went to the page corresponding to another product (e.g., a Samsung™ Galaxy S5) or even went to an unrelated page (e.g., the ‘Samsung™ Refrigerator’/home appliance section of the marketer's web site). In this example, the former should be assigned a higher score as compared to the latter. Therefore, there is a need for methods and systems that take the relevance between the context of the targeted email and the interactions done on the website into account when assigning scores for activities to generate high quality leads.

Similarly, upon opening the link, time spent and interactions done may be different for various users. For example, after opening the link from the email, one user carefully read all the information whereas another user quickly bounced off. In this example, the former should be assigned a higher score compared to the latter. Therefore, there is a need for systems and methods that take user interactions done on the website into account when assigning the scores for activities to generate high quality leads.

Therefore, highly qualified leads can be generated by taking into account the prospect's context, sentiment, interactions in assigning the scores so that even after performing the same activities, the ones that are more relevant gets a higher score and are taken to the next level (e.g., sent to a sales team) as compared to the others that are relatively less relevant. Using conventional techniques, these users will get the same score, resulting in some disappointment for the sales team along with wastage of resources and money.

Example use cases are discussed below with a user browsing related pages, spending more time on a marketer's site, which signifies higher interest and therefore that user gets a higher score. In embodiments, a user's score is based on the user's interactions on the marketer's website, actions tracked via web tracking, and clicking on an ad in an email, which can be tracked via email tracking.

Consider a use case where a prospect who was sent an email with a link to a product site for a smartphone. The prospect clicked on the link, but just after navigating to the product site, he clicked on another section (e.g., a consumer appliance section of the web site) and navigated away from the smartphone page to a refrigerator section of the site instead of reviewing information related to the smartphone product.

According to an embodiment, this prospect will be given a lower score as compared to another prospect that clicked on the same link and remained on the smartphone product page while spending considerable time and reading all the information related to the smartphone. In this embodiment, the ‘context of the targeted email’ (e.g., the email with the link to the smartphone product site) and the ‘context of the prospect website visit after clicking the link’ are both taken into account when assigning a score to the link click in the targeted email.

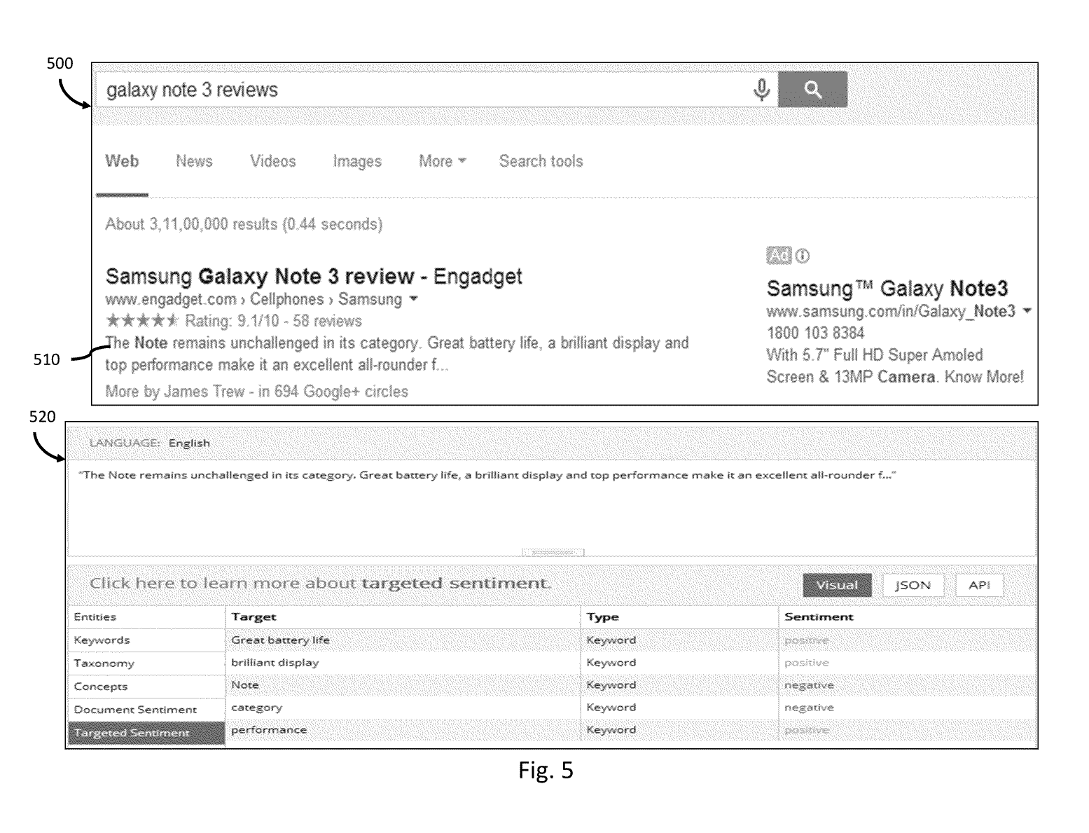

The following hypothetical use cases will illustrate example lead scoring in more detail. Consider the case where an online customer acquisition program has been launched for a recently introduced smartphone. The customer acquisition program is launched to capture details of all potential customers (e.g., leads and prospects) who are evaluating or searching for that specific smartphone. An example of an ad placed as part of such an acquisition program is depicted in FIG. 5 in the context of a “Galaxy Note 3” smartphone. When a user searches for some search term e.g., “Galaxy note 3 reviews” on a search engine, the acquisition program will also present a Samsung™ Galaxy Note 3 ad in side bar as seen in FIG. 5.

When the user clicks on this ad, he will navigate to a ‘Galaxy Note 3’ landing page. On this page, the user can learn more about the product and can also fill a form to express his interest in a ‘10% off offer’ on this smartphone.

Also, this user who is coming after clicking this ad has most probably looked at the following text displayed in the search result alongside the ad: ‘The Note remains unchallenged in its category. Great battery life, a brilliant display and top performance make it an excellent all-round . . . ’ This user will have the following immediate context/mindset: he has read about battery, display and performance, and his mindset for these features is positive. If the immediate feeling/context of the user is highly positive towards marketer products or services, the user is assigned a higher score so as to route him to sales team at the earliest and make him convert thereby capitalizing on the positive sentiment in the mind of the customer.

For example, consider a hypothetical where the TechRadar site/blog includes the following review for a smartphone (e.g., a Samsung™ Galaxy Note 3) with a link to a product page for the smartphone:
The Samsung™ Galaxy Note 3 can be defined by one word: evolution.
The camera has evolved to give clearer, faster snaps. The fitness-tracking abilities of the Note 3 are enhanced over the Note 2 by packing in a more powerful S Health app and a dedicated heart rate monitor on the rear. A fingerprint scanner adds to the most secure Galaxy phone ever made.
The battery is larger, the screen bigger and brighter, the processor quicker and the design altered.

In this case, a user who is coming after reading this review on a third party review site has a highly positive mindset towards the product and he should be assigned higher score so as to route him to sales team at the earliest and make him convert thereby capitalizing on the positive sentiment in the mind of customer.

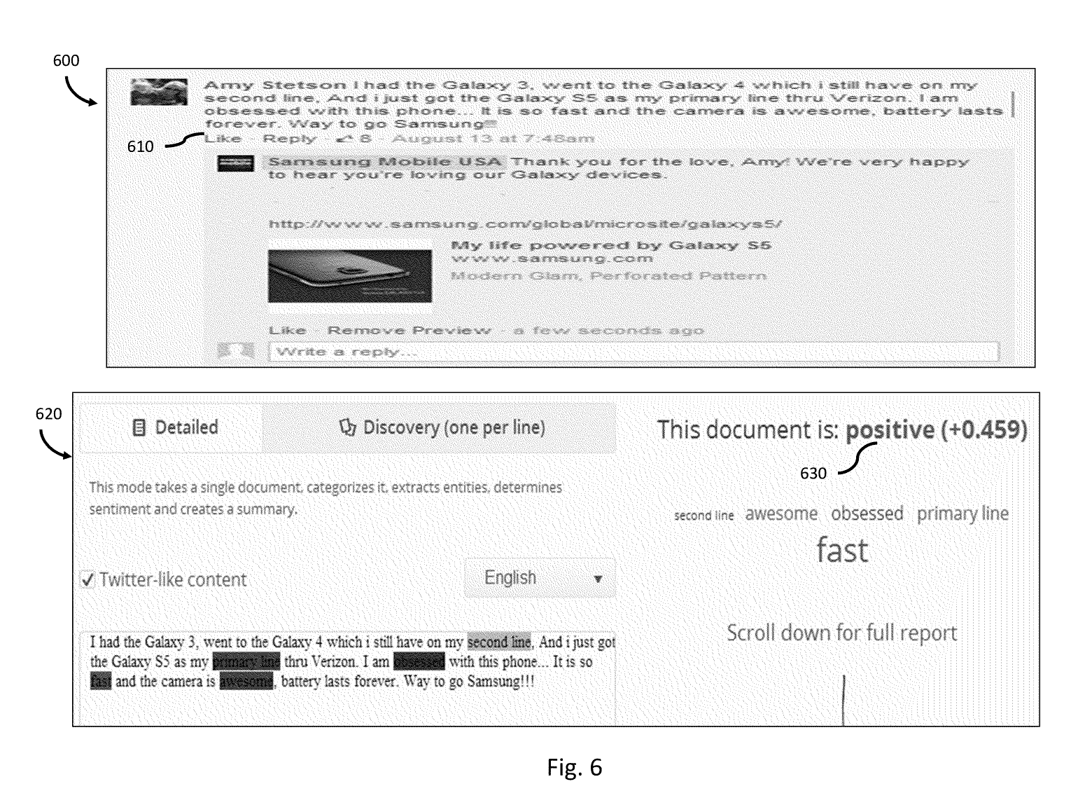

In another example, consider a Facebook® user who has posted a highly positive comment for ‘Samsung™ Galaxy S5’ and the producer's team (e.g., a Samsung™ representative) replied back to this user thanking her. An example of such a conversation is depicted in FIG. 6. At this point, if a second user comes to a Galaxy S5 site by clicking on the link mentioned in this conversation, then an embodiment will assign a higher score to this visit by the second user. This is done in order to route this second user to a sales team at the earliest convenience so as to convert the second user to a customer, thereby capitalizing on the positive sentiment in the mind of this potential customer/purchaser.

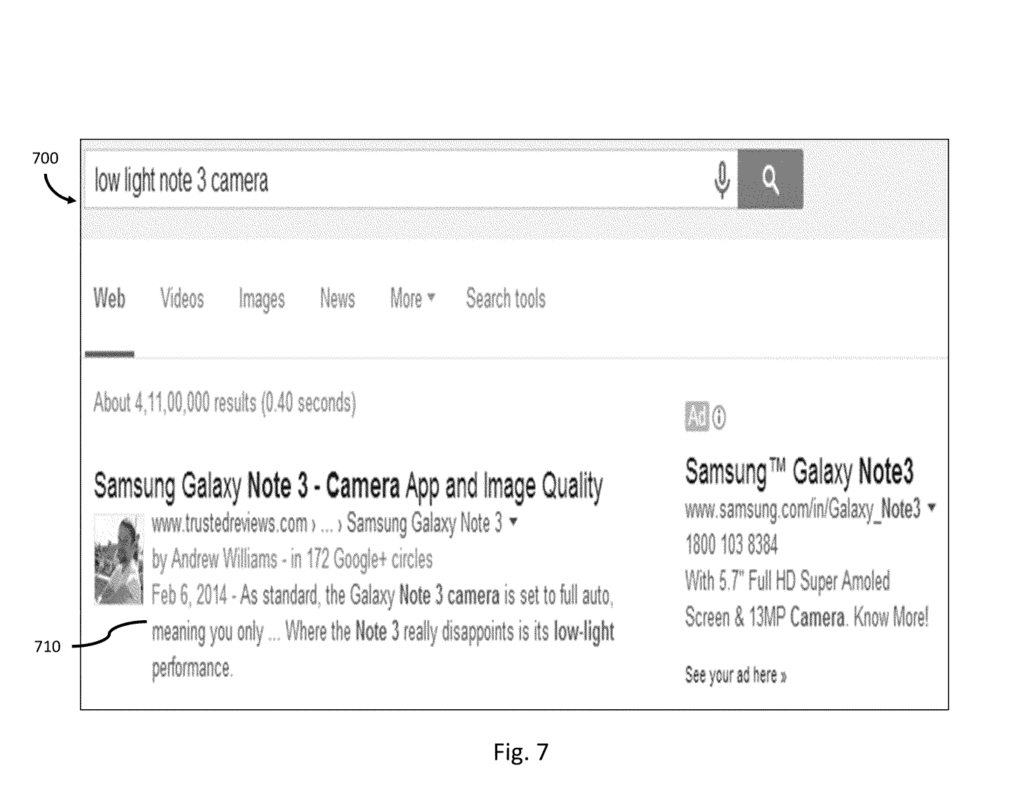

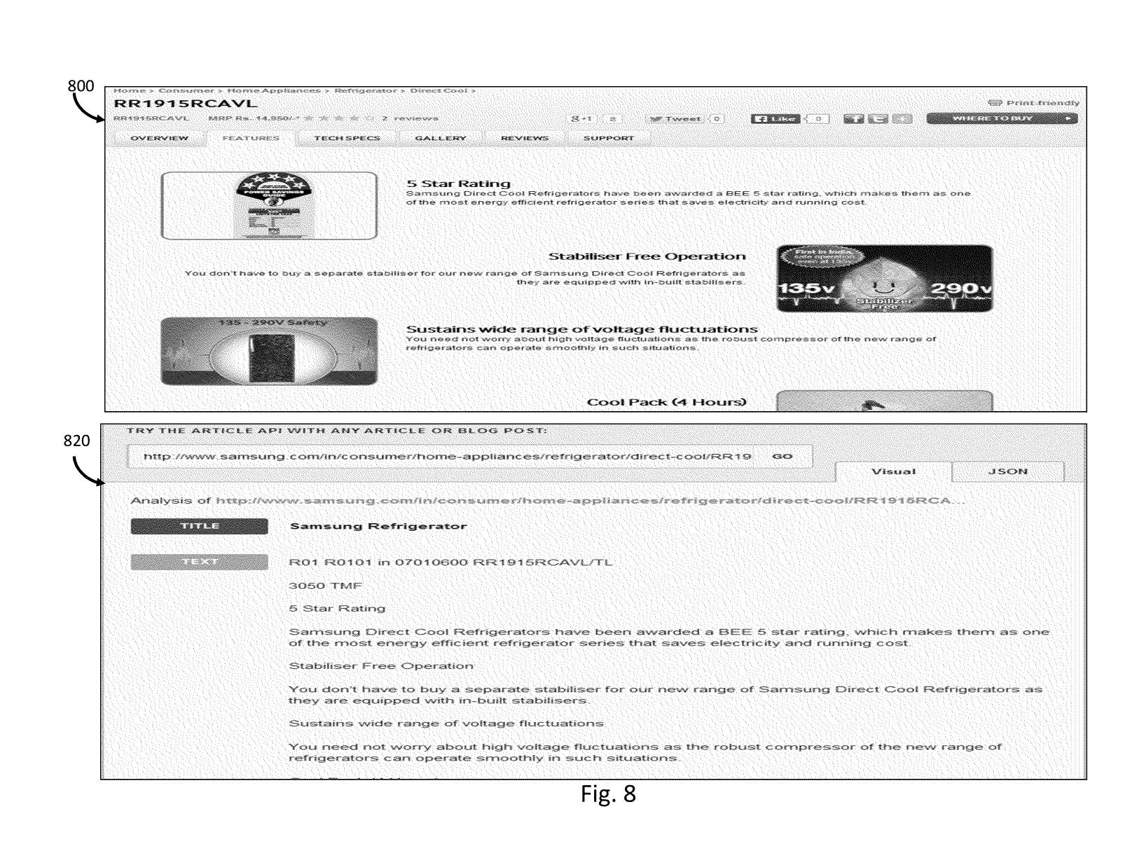

In one example, if another user searched for a search term ‘low light note 3 camera’ and this user is presented with a few search results and an ad for a corresponding product (e.g., a Samsung™ Galaxy Note 3), where a first search result says ‘Where the Note 3 really disappoints is its low-light performance.’ In this example, which is illustrated in FIG. 7, this user has the following immediate context/mindset: He is interested in camera especially the performance in low light conditions and his mindset for them is negative. Hence, given his interest and knowledge, he should be given a medium score and in a nurturing program, he should be given specific inputs featuring camera and its low light performance.

In another example, a prospect that has a medium score is marked as a ‘Warm Lead’ and is assigned to a nurturing program. In a nurturing program, targeted email with a product link or information is sent to certain prospects (e.g., warm leads) to gauge their interest in the product. If the prospect clicks on the link, he is given a score as defined in the corresponding rule.

To provide effective, timely marketing information to potential consumers, it can be desirable to understand how potential consumers are discussing the products to be marketed to them. For example, if a company launches a new smartphone product having a built in camera with a 13 megapixel sensor, 1080p video recording capabilities, and other features/capabilities, it may be desirable to providing marketing information highlighting features of the smartphone's camera that may be of particular interest to interested customers. If the addition of low light performance/capability to a smartphone camera generates interest to a group of customers, such as customers in a particular demographic, a marketer might desire to emphasize low light performance in marketing materials targeted to members of that demographic. Or if customers dislike the 1080p video recording quality, a marketer may deemphasize the video recording aspects, while emphasizing other aspects of the smartphone's camera. Further, these consumer preferences may change over time.

For example, if the smartphone's camera initially has a software bug that corrupts recorded video files, which generates a significant negative reaction by customers and potential customers, a marketer might deemphasize the video recording aspects of the smartphone's built in camera. But later, if updated video recording software is provided to fix the software bug, and sentiment toward the video recording capabilities changes, the marketer might wish to harness the positive sentiments about the software fix and emphasize the “improved” video recording capabilities of the smartphone. However, it can be difficult to accurately assess customer sentiment about a new or upcoming product.

Embodiments according to the present disclosure seek to assess public sentiment about marketable products by capturing information posted to various social media Internet sites, such as Facebook®, Twitter®, etc., and using that information to tailor marketing communications and send them to the right target populations. By collecting comments regarding a particular product of interest, a marketer may be able to assess consumer sentiment regarding the product and, if some of the collected comments highlight particular features of the product, identify those features that are generating discussion, whether positive or negative, about the product.

The gathered comments may then be analyzed for the commenter's sentiment to identify whether the comments praise or disparage the product or its features. In addition, information about the commenters may be used to identify demographic information associated with the comments, and thus to generate information regarding how different demographics view the product and its features. For example, considering the smartphone example, potential consumers in the 19-29 year age range may comment positively about the high-resolution 13 megapixel sensor of the phone's camera, while the 45-54 year age range may show strong positive feelings about the convenience of the smartphone's battery life. Thus a marketer may be able to generate and provide different marketing materials to different groups of potential customers based on their demographics.

Continuing this example, the marketer may generate targeted email messages using one or more database of potential customers' email addresses, demographics and/or other information. For potential customers in the 19-29 year age range, the marketer may generate an email with a subject line that states ‘Stunning 13 megapixel camera included in new smartphone from XYZ Company’ or otherwise highlights that feature, while, for potential customers in the 45-54 year age range, the marketer may generate an email with a subject line that states ‘Excellent battery life and camera features in new smartphone from XYZ Company’ Or otherwise highlights that feature. In addition, when generating these emails, the marketer may also choose to avoid mentioning or much discussion of features about which there has been significant negative commentary. Thus, while email messages to the 45-54 year age range may emphasize the smartphone's battery life, and might mention the 13 megapixel camera sensor, it may omit discussion of issues related to low light performance of the smartphone's built in camera or buggy 1080p video recording functionality.

However, because in some embodiments user comments may be continuously gathered from one or more social media Internet sites, once the software update to resolve the buggy 1080p video recording is released, and user comments begin to view the update and the video recording functionality positively, the marketer may revise later marketing emails, or even revise dynamic content referenced by previously-transmitted emails, to include information regarding the 1080p video recording functionality.

Thus, by retrieving and analyzing user-generated comments in real-time from one or more social media Internet sites, a marketer or marketing organization may be able to generate more relevant, timely, and targeted marketing materials for potential consumers, including targeting demographic groups according to their respective interests as assessed from such comments.

As used herein, the term “marketing system” refers to a computerized system for one or more of managing information about one or more consumers or leads, storing and accessing information about the one or more consumers, targeting one or more of the consumers, planning and executing marketing campaigns, and tracking the performance of marketing campaigns. In some embodiments, a marketing system can employ one or more computing devices or computer systems in communication with each other to provide the functionality of a marketing system. For example, in one embodiment, a marketing system may include different computer systems for managing information about one or more consumers, for storing and accessing information about the one or more consumers, planning one or more marketing campaigns, executing one or more marketing campaigns, and/or tracking the performance of one or more marketing campaigns. In some embodiments, a marketing system may be embodied entirely within a single computer system. For example, a single application may embody all of the functionality of a marketing system and provide one or more tools (as described below) for performing the functions of a marketing system.

As used herein, the term “marketing campaign” refers to a process that includes identifying a target product(s) to be marketed, identifying a target population to receiving marketing information based on features and characteristics of the target product(s), and generating and sending communications to the target population about the target product(s). For example, in some embodiments, new products may be identified as target products and target populations may be identified based on demographic information about demographics who bought a previous version of the new products, or demographics of those who bought similar types of products. In some examples, a user of a marketing system can identify a target product and target product features. Sending marketing communications can include automatically generating electronic or printed materials about the target product that emphasize interesting features of the target product and may be sent once, or repeatedly over time, to members of the target population. Marketing campaigns can also include obtaining feedback regarding the effectiveness of the marketing campaign and changing the content of communications or the target population(s) based on the feedback.

As used herein, the term “tools” refers to computer-implemented functions, such as applications or procedures, for performing one or more tasks. In some embodiments, tools may provide user interfaces to enable a user to interact with the tool to accomplish a particular task. For example, tools discussed herein include tools for planning a marketing campaign, tools for targeting particular consumers or groups of consumers, executing a marketing campaign, and tracking a marketing campaign. In some embodiments, multiple tools may be incorporated into a single software application. For example, a tool may combine the functionality of aggregating and organizing information about potential consumers and for targeting particular consumers or groups of consumers for a marketing campaign. In some embodiments, multiple applications may work in concert to perform as a tool. For example, a tool for executing a marketing campaign may employ a software application for sending emails, a separate software application for generating marketing materials, and a separate software application for extracting or importing contact information regarding targeted consumers.

As used herein, the term “real time tracking system” refers to a computerized system for capturing data from a data source in real time, or near-real-time, or for capturing data from a data source for use in a real-time or near-real-time process, or both. For example, in some embodiments, a marketing system may execute a marketing campaign by, in part, generating and transmitting marketing information to a target population. However, during this process, the real time tracking system may capture data relevant to the marketing campaign which causes the marketing campaign to be modified during its execution. Thus, in one embodiment, information sent to one consumer may differ from information sent at a later time to another consumer, or the same consumer, based on information captured by the real time tracking system. Further, in some embodiments, a real time tracking system may also be configured to request and/or receive data from a data source as the data is generated. For example, in some embodiments, a real time tracking system may transmit a request for data to a data source and, as relevant data is generated by the data source, e.g., as users post comments to a social media site, the data source provides the data to the real time tracking system.

As used herein, the term “email tracking” refers to collecting information regarding user interactions with a variety of marketing communications. The email tracking techniques described herein are not limited to email communications and can be performed for other types of marketing communications, such as, but not limited to, text messages, social media communications, and other forms of communication.

As used herein, the terms “sentiment” and “customer sentiment” refer to an emotion, affinity, or attitude and may refer to an individualized sentiment, e.g., of a single consumer, or to an aggregate sentiment, e.g., of a plurality of consumers. For example, in the context of a marketing system, it may be useful to understand consumer sentiment towards a product to be marketed. Thus, it may be useful to estimate a consumer's attitude or reaction to a product or features of the product. For example, a user may like or dislike a product, or be desirous or indifferent towards a product. Further, sentiments may also include a strength or magnitude. For example, a sentiment may be strong or powerful, or may be weak, lukewarm, or tepid. In addition and according to context, “sentiment” may also refer to a measured or calculated value reflecting such an emotion, affinity, or attitude. For example, according to some embodiments, a software application may attempt to calculate a sentiment associated with text. Such a software application may analyze the semantic meaning of the words in a portion of text and calculate a score, such as a positive or negative floating-point value between −1 and 1, though other scales, ranges, or values are within the scope of this disclosure. In addition, in some embodiments, a sentiment may also include a confidence score indicating the determined accuracy of the calculated sentiment. Thus, a sentiment score may have a value of 0.998 indicating a strongly-positive sentiment, however, it may only have a confidence score of 0.6, indicating that while the sentiment is apparently strongly positive, there is uncertainty as to the accuracy of the score, potentially due to ambiguous phrasing, multiple possible senses of one or more words, misspellings, or lack of punctuation.

As used herein, the term “sentiment engine” refers to a software application (or applications) that are configured to calculate sentiments of expressions that have been provided to the sentiment engine. For example, one embodiment of a sentiment may be configured to receive text strings with natural language expressions and to analyze these text strings to calculate a sentiment score for the expressions. Other embodiments may be configured to receive spoken words and calculate sentiment scores for the spoken words and/or phrases. Further, a sentiment engine, in some embodiments, is configured to output data indicating the sentiment score and the associated words or phrases, such as by generating textual strings or binary data streams.

As used herein, a “computing device” refers to any type of computing device configured to communicate with another computing device over a network to access information, including mobile computing devices and other computing devices. A mobile computing device may allow mobility to the user during at least operation and may include, for example, a mobile phone, a smartphone, a personal digital assistant (PDA), a tablet device, and other mobile computing devices. In comparison, other computing devices may be more stationary, may include relatively more processing power and memory space than those of mobile computing devices, and may have an operating system that is more sophisticated than operating systems typically running on mobile computing devices. A laptop, a personal computer, a desktop computer, and a server are examples of such other computing devices.

As used herein, “application” refers to a program configured to access and retrieve information hosted on a computing system (e.g., content from a web site hosted on a server, web management system, and/or a content delivery system) and to render the information at a user interface. Examples of such an application include a web browser, a script or a plug-in that runs within a web browser, a program that is hosted in a web browser, a program that is separate from but that interfaces with a web browser such as a social media application, and other types of programs capable of using local memory and a rendering engine to access and render content.

Embodiments according to this disclosure may be advantageously used in combination with one or more marketing systems, such as, for example, Adobe® Campaign®, to generate and execute a marketing campaign. A suitable marketing system may include a number of components to assist a marketer or marketing organization with developing and implementing a marketing campaign, particularly in the case of targeted marketing campaigns. A marketing system may include a number of different tools to enable a marketer, or marketing organization, to plan a marketing campaign, select a target consumer group, execute the campaign, and the track the effectiveness of the campaign. These tools may be accessible to the marketer through various graphical user interfaces (GUIs) at a user computer.

An example marketing system usable in conjunction with real-time consumer sentiment analysis includes multiple interconnected components. These components typically include one or more data repositories to store information about potential customers, as well as planning tools, tools for targeting potential customers, tools for executing the campaign, and tools for tracking the progress and effectiveness of the marketing campaign.

Example Systems

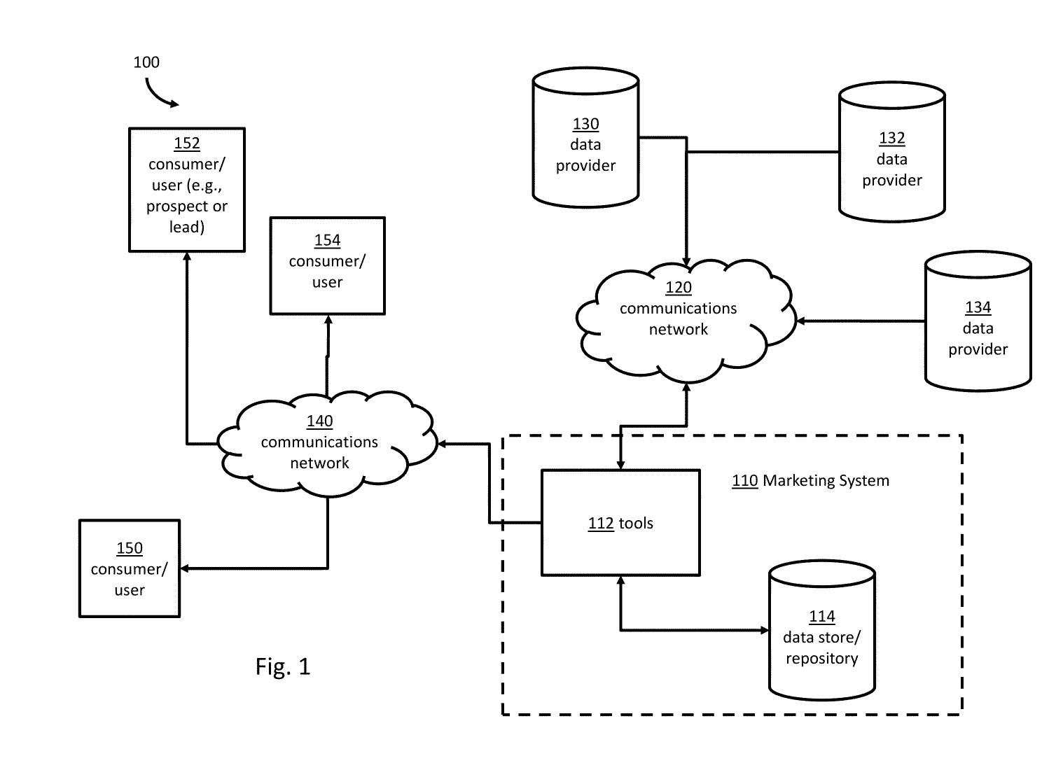

FIG. 1 shows an example marketing system 110. The marketing system 110 includes one or more computer systems and tools 112 to allow users to plan and execute marketing campaigns and one or more data stores 114 for storing information about consumers, information about products to be marketed, and information about effectiveness of past marketing campaigns.

The marketing system 110 is connected by a communications network 120 to one or more data providers 130-134. These data providers 130-134 gather and analyze information about individuals for use in marketing campaigns. For example, a data provider may create records for a number of different individuals and store as much known information about them as possible, such as name, address, date of birth, gender, interests, hobbies, friends and family, etc. A marketer or marketing organization may then purchase data from these data providers and import that data into the marketing system's data store 114 for use in planning and executing marketing campaigns, or may access such data from the data providers' databases on an as-needed basis. In an embodiment, a marketer or marketing organization can identify a target product and product features using marketing system 110.

A significant component of many suitable marketing systems is the potential customer information. Customer information can be obtained from a variety of different sources and may be stored in multiple data repositories for use by a marketing organization. To provide easier access to what can be a substantial amount of information, some suitable marketing systems include functionality referred to herein as a “customer view.” A customer view provides an integrated aggregation of personally-identifiable information (“PII”) or other information about a specific individual. Such information can include a name, address, telephone number, email address, social media contact information, friends, family, known likes or dislikes, known hobbies, etc. In short, any data about a customer that can be gathered and stored. This information can then be extracted from the one or more data stores 114, 130-134, integrated into a single profile of the customer, and presented to a marketer for analysis. Or, in some embodiments, the single customer view can be accessed by automated tools to identify particular characteristics, such as demographic information, hobbies, interests, or other information that might be useful when generating a marketing campaign or other marketing materials.

The PII may be obtained in any number of ways, such as by purchasing it from a data aggregator as discussed above, retrieving publicly-available information from the Internet, accessing customer profiles or records maintained by the marketing organization itself, integration with other backend systems like Salesforce, or other information source. In some cases, data may be gathered slowly or piecemeal. For example, a marketing organization may ask visitors to a website to answer a few survey questions. Subsequent visits may sometimes trigger an additional small number of survey questions. In such a way, a user may be willing to provide a small amount of information when they might otherwise be unwilling to respond to a lengthy survey. The marketing system 110 will receive this information and incorporated it into its data store(s) 114.

The marketing system 110 is also connected by an electronic communications network 140 to one or more potential consumers 150-154, such as by email, social media sites or platforms, telephone or other communications method. In some cases, the marketing system 110 may be connected to or in communication with customers and potential customers by non-electronic means, such as by direct mail. These different means of communication are generally referred to as “channels” or “communications channels.” The marketing system 110 employs these channels to send marketing information, such as email messages, to the consumers 150-154 with information or offers regarding one or more products or services. Thus, the entire system 100 shown in FIG. 1 provides the marketing system 110 with information regarding consumers, the tools to create and distribute marketing information to those consumers, and the mechanisms by which to pass that information along to the consumers.

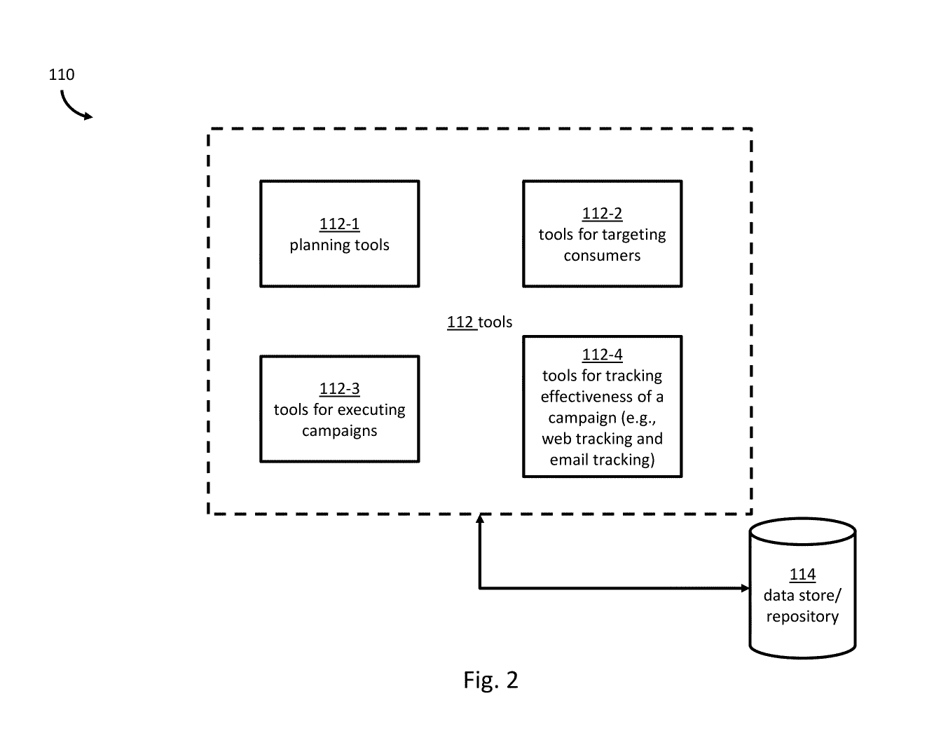

As discussed above, a marketing system 110 includes, in addition to the data stores or repositories 114, tools for planning and executing marketing campaigns. FIG. 2 shows some example components of the marketing system 110 of FIG. 1. These tools include planning tools 112-1, targeting tools 112-2 for targeting particular consumers or groups of consumers, tools for executing marketing campaigns 112-3, and tools for tracking the effectiveness of a marketing campaign 112-4. These different tools work together to enable a marketer or marketing organization to effectively plan and execute marketing campaigns.

In the embodiment shown in FIG. 2, the planning tool 112-1 allows a marketer to select a product to be marketed, identify the features of the product to be emphasized or promoted, identify characteristics of potential consumers for targeting, select different channels through which to send marketing information, and embed tracking information into marketing communications or related websites. For example, the planning tool 112-1 can provide integrated views of different targeted consumers based on PII acquired from one or more data aggregators, or developed over time by the marketing organization itself. The planning tool 112-1 can also provide graphical tools to enable a marketer to identify products and features to be marketed, and identify demographic groups of interest for a marketing campaign, such as by specifying desirable characteristics of the target consumers.

In addition, the planning tool 112-1 can provide options for different channels through which to send marketing materials, frequencies at which to send materials, and the types of materials to send. For example, one suitable system employs a planning tool 112-1 to allow a user to select from a pool of communication channels such as email, direct mail, text messages, telephone calls, faxes, or Internet advertisements. In addition, a marketer or marketing organization may use the planning tool 112-1 to determine or establish how often marketing messages are communicated. For example, the planning tool 112-1 may include information indicating a change in effectiveness for different communication channels depending on the frequency of communication. If, in one embodiment, email messages sent every two to three days generate more frequent returns, rather than those sent daily or weekly, the planning tool can assist the marketer in selecting the frequency of communication.

In addition, the planning tool 112-1 can assist in determining whether to send coupons, rebates, package offers, or other types of incentives or information as a part of a particular marketing campaign. The planning tool 112-1 also provides tools to create or import marketing messages. For example, a marketer may be able to generate content, such as graphics and text, and subject line information for email messages to be sent as a part of a marketing campaign.

The planning tool 112-1, in some embodiments, may also include functionality that allows the marketer to embed tracking information into such content. For example, when creating content for an email marketing campaign, the marketer may include Internet links (or Uniform Resource Locator or “URL”) to an advertised product, but insert a link that takes the user to a page that, in addition to providing the desired information or shopping experience to the user, also transmits information back to the marketer. In addition, the planning tool 112-1 may be capable of generating information to leverage such functionality in third-party web sites, such as Amazon, to enable tracking functionality to track whether the user has clicked on a link in the email message, and whether the user ultimately purchases the advertised product, including more fine-grained information such as whether the user added the product to their “shopping cart,” how long the product sat in the cart, and whether the user abandoned the cart, or later removed the product from the cart. Such information may be received by the marketing system and used by a tracking tool 112-4, which is described in greater detail below.

A part of planning a marketing campaign includes selecting the target audience for the campaign, and some suitable embodiments, such as the embodiment shown in FIG. 2, include tools 112-2 for selecting a target population for a marketing campaign. For example, some embodiments may employ targeting tools to identify potential consumers for inclusion within a marketing campaign based on scores assigned to the potential consumers. The scores may be assigned based on web tracking and email tracking Some such tools may select potential consumers who have been categorized as hot leads based on their scores. In an embodiment the web and email tracking can be performed by tracking tools 112-4 for tracking the effectiveness of a campaign. The web tracking can, for example, collect information indicating a referral context and a degree of sentiment from a referral source referring a user to a web page associated with a product or service. Also, for example, the email tracking can collect information indicating relevance between a context of a marketing communication (e.g., a targeted email) sent to the user and the user's interactions with a marketer's web page. In cases where the marketing communication is an email, a link for the marketer's web page can be specified in the email and the relevance between the context of the targeted email and the user's interactions on the web page can be determined based on a total time of the user's interactions with content of the web page that is relevant to a specified product. Example tools 112-4 are described below.

Other tools 112-2 may identify gross categories of personally identifiable information (PII), such as a broad demographic group, e.g., all women between the ages of 30 to 40. Such a tool may enable a marketer or marketing organization to quickly identify a target population for more generalized marketing information directed to the broad demographic group as a whole. Some embodiments may also employ more customizable control over marketing materials and allow more targeted marketing campaigns.

In some embodiments, the planning tool 112-2 may also comprise functionality to enable a user to adjust a marketing campaign in real time based on information collected from social media sites. As will be discussed in greater detail below, a marketing system 310 may obtain information from social media sites for use with planning a marketing campaign. The information received from the social media sites may affect rankings of particular keywords or may affect the relevance of particular features of a product with respect to different target demographic groups. By providing such information to a user in a graphical display, such as by providing selectable features in a ranked manner, a user may be able to quickly identify a particular target demographic, select one or more features of particular relevance to the demographic based on the social media site information, and thus tailor the marketing campaign appropriately. Further, such functionality may be employed while the marketing campaign is executed to orchestrate the marketing campaign in real time. For example, if a particular feature becomes more relevant to a particular target demographic, the planning tool 112-2 may allow a user to visually detect the increased relevance of the particular feature, and use the tool to incorporate the feature into the marketing campaign with respect to one or more target demographics. Thus, the planning tool may be employed to graphically orchestrate a marketing campaign in real time based on information obtained from one or more social media sites.

The exemplary embodiment shown in FIG. 2 also includes tools 112-3 for executing marketing campaigns once the campaign has been planned and a target population has been selected. The execution tool 112-3 provides functionality to generate and transmit marketing messages to the target population using the channels identified by the planning tool. For example, the execution tool 112-3 may be configured to create email messages based on the content created or imported in the planning tool, or to output print materials for a direct mail marketing campaign. The execution tool 112-3 can also be configured to transmit the email messages to the target population.

Further, the execution tool 112-3 can be configured to schedule periodic transmissions of the marketing information. For example, in one example marketing campaign, the marketer may have developed an initial marketing message, a follow-up message, and a “final offer” message to be sent over the course of two weeks to advertise a sale for a client. The execution tool 112-3 can be supplied with information regarding the timing of particular messages, how to handle “bounceback” messages, such as from an unreachable email address, and the time of day at which to send the messages.

Once a marketing campaign has begun, it can be useful for the marketer or marketing organization to measure the performance of the campaign. Thus, the exemplary embodiment shown in FIG. 2 includes a tracking tool 112-4 that receives, analyzes, and stores tracking information during the course of a marketing campaign. For example, an email sent by the campaign may send tracking information to the tracking tool 112-4 when the email is opened, which the tracking tool 112-4 may store in the repository. In addition, as alluded to above, tracking information may be embedded within web pages corresponding to Internet links within a marketing email, or may be created as a user browses or shops on an Internet site associated with the marketing email.

As shown in FIG. 2, tracking tools 112-4 can perform web tracking and email tracking. For example, tracking tools 112-4 can collect and analyze referral source context, such as the context of a referring web page, and a degree of sentiment at a referral source, such as the degree of sentiment (positive or negative) at the referring web page. Also, for example, tracking tool 112-4 can collect information indicating relevance between the context of a targeted email and a user's interactions on a page whose URL is indicated in the targeted email.

For example, in some embodiments, a targeted consumer receives an email as a part of the marketing campaign and opens the email, at which time tracking information is sent to the tracking tool 112-4 indicating that the consumer has opened the email and indicating the time the email was opened. The consumer then clicks a URL within the email, which opens the consumer's web browser, or a new tab in the consumer's web browser to navigate the consumer to the selected web page. In this case the web page is part of an online retail store. Information within the URL causes the web page to transmit information to the tracking tool 112-4 indicating the identity of the consumer that clicked on the URL and the time at which the consumer clicked on the URL.

As another example, if the consumer has a user account at the online retail store, information about the consumer may be extracted from the user's account and incorporated into the data store 114. In this example, the URL leads to a web page offering the new smartphone product for sale, and includes an option to add the phone to the consumer's shopping cart. When the consumer selects an option to add the phone to her shopping cart, the web page sends tracking information to the tracking tool 112-4 indicating that the consumer has added the phone to the shopping cart. Subsequently, the user may remove the phone from her shopping cart, in which case, the web page sends additional tracking information indicating that the consumer has removed the phone from her shopping cart. In such a case, the tracking tool 112-4 stores that information in the data store 114 and may send a message to the execution tool 112-3 to send a further email to the consumer to encourage her to purchase the phone, such as a coupon or discount offer.

Alternatively, the consumer may simply abandon her shopping cart without purchasing any of the items, including the phone. Upon detecting that the consumer has abandoned her shopping cart, with the phone in it, the web page may transmit tracking information to the tracking tool 112-4 to indicate that the consumer has abandoned the purchase of the smartphone. The tracking tool 112-4 may store this information in the data store 114, and may also transmit a message to the execution tool 112-3 to send a further email to the consumer to encourage her to purchase the phone, such as a coupon or discount offer. In some cases, the consumer may purchase the phone, in which case, the web page may transmit tracking information to the tracking tool 112-4 indicating that the user has purchased the phone, which the tracking tool 112-4 may store in the data store 114.

The tracking tool 112-4, upon receiving various types of tracking information, including those discussed above, may store some or all of such tracking information in the data store 114. The tracking tool 112-4, in some embodiments, includes functionality to allow a user, such as a marketer, to access the tracking information and to request or to generate tracking reports. For example, some embodiments of the tracking tool 112-4 include functionality to allow the marketer to view or determine statistical information regarding the number of consumers contacted by email during the marketing campaign, the number of users who opened the email, the number of users who clicked on a URL in the email, and the number of users who purchased the marketed product. Such statistical information may provide the user, such as the marketer or the marketer's client, with information regarding the effectiveness of the marketing campaign. If a large percentage of targeted consumers purchased the marketed product, the marketer or the marketer's client may be able to more easily replicate the success by adhering to a similar marketing strategy in the future.

Alternatively, if a small percentage of the targeted consumers purchased the product, the marketer may be able to use the tracking information to determine where or why the campaign may have failed. For example, if only a very small number of targeted consumers opened the email, the marketer may be able to revise the types of emails sent or the subject lines of the emails to better capture interest in the email. Alternatively, if a significant number of targeted consumers opened the email, clicked on the link, and added the product to their cart, but ultimately abandoned the shopping cart, the marketer may conclude that the price of the product was too high, and may consider alternative marketing strategies, including rebates or other incentives.

Thus, marketing systems 110, in some embodiments, may provide end-to-end tools for planning, executing, and analyzing the effectiveness of marketing campaigns. And embodiments according to the present disclosure may integrate with such marketing systems 110 to provide enhanced marketing intelligence for planning and executing marketing campaigns, such as by providing real-time information regarding consumers' interests and focuses regarding particular products, which may allow a marketer or marketing organization to better plan a marketing campaign, or to adjust a marketing campaign on-the-fly to keep pace with shifting consumer sentiments.

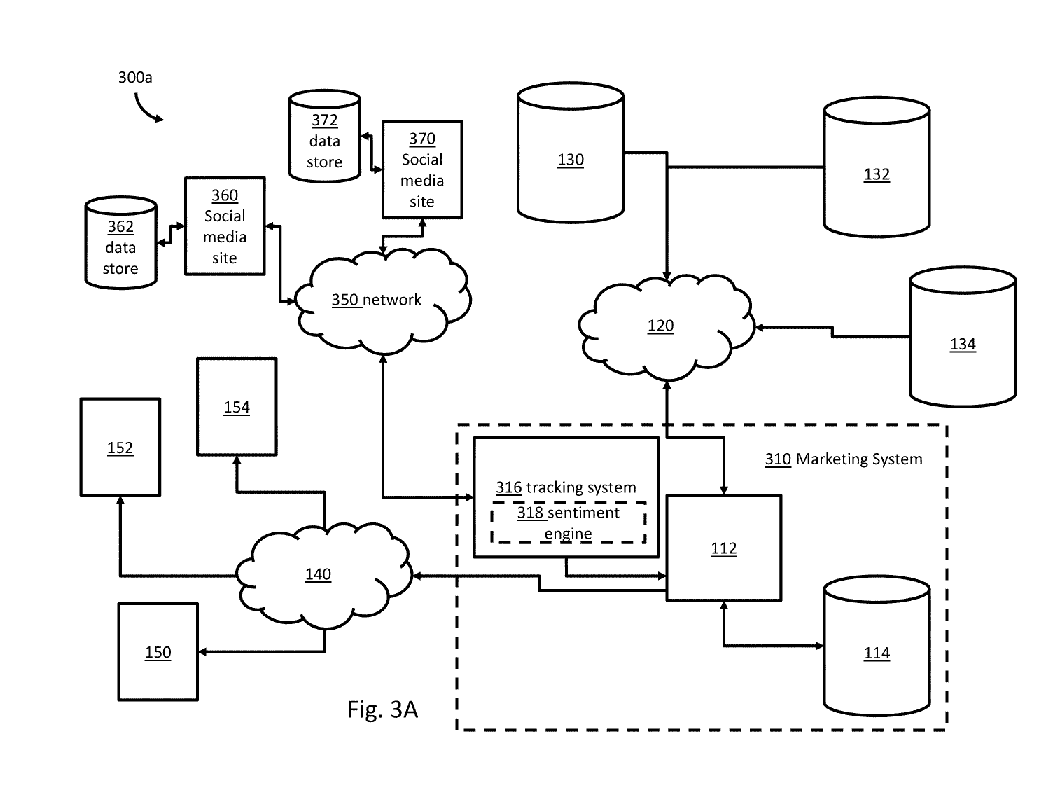

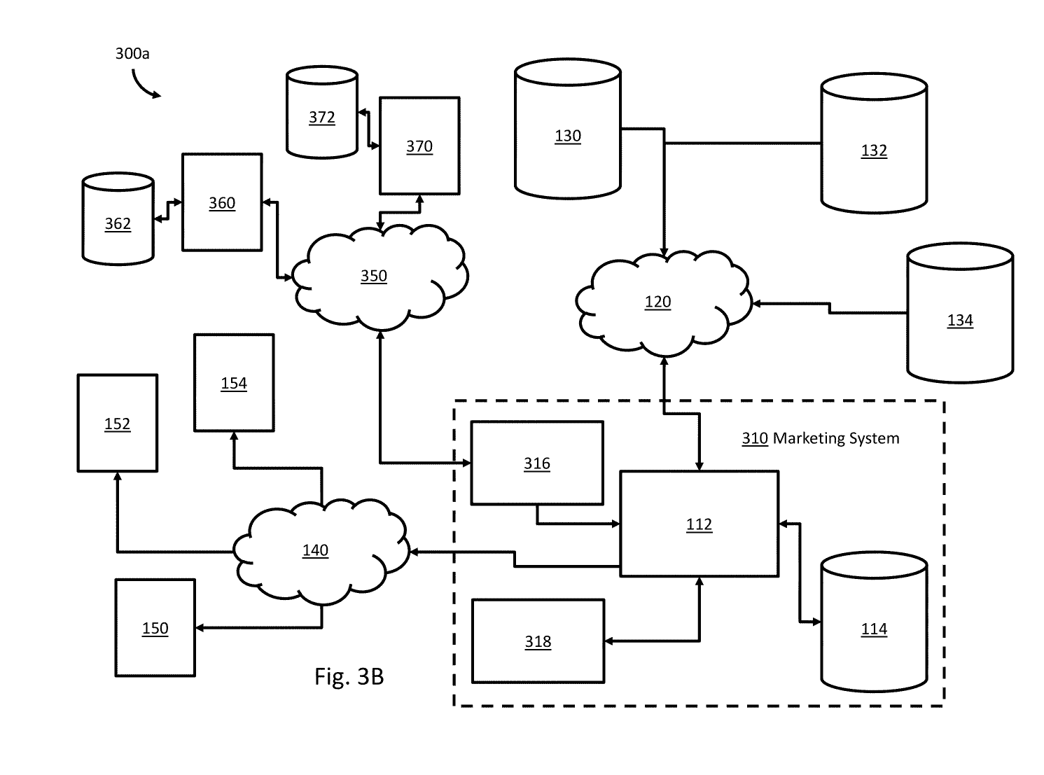

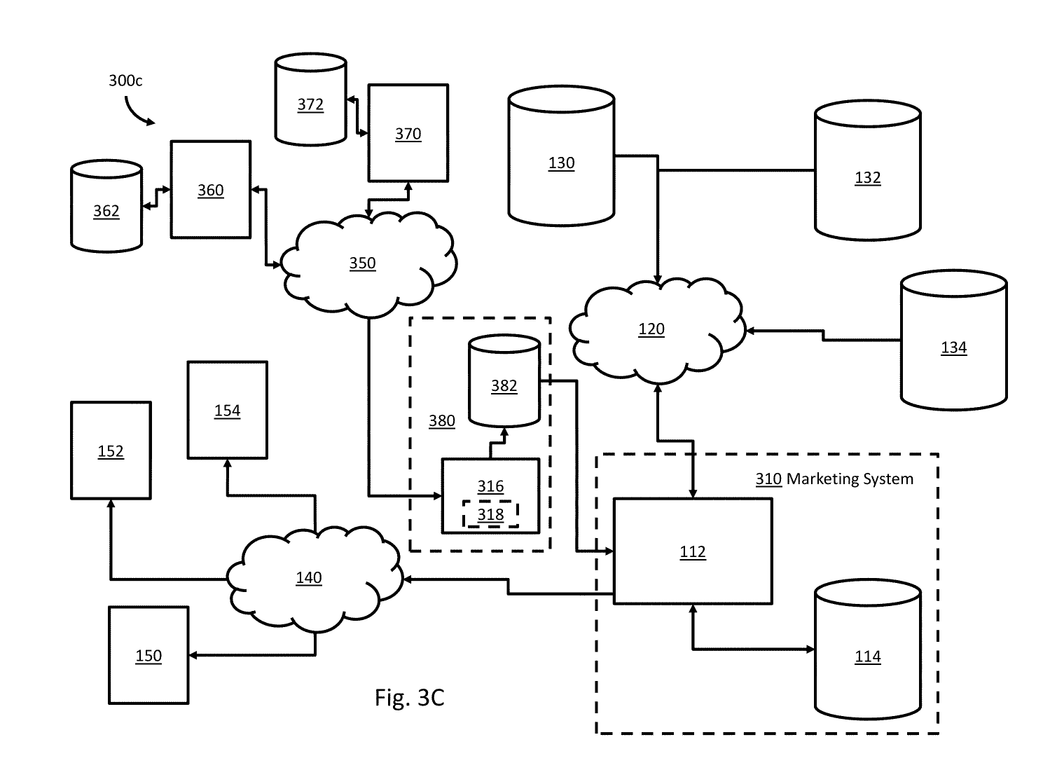

FIG. 3A shows a system 300a for providing real-time marketing campaigns according to one embodiment. The system 300a includes a marketing campaign system 310, which provides one or more data repositories or data stores 114 for storing information regarding individuals or other entities, such as businesses, that may be useful in providing targeted marketing information to those persons. The marketing campaign system 310 also includes one or more tools 112 for use in planning a marketing campaign, targeting a population of consumers, executing the marketing campaign, and tracking the effectiveness of the marketing campaign as described above with respect to the exemplary systems shown in FIGS. 1 and 2. The system 300a further comprises a real-time tracking system 316 for capturing consumer information and sentiment in real-time or near-real-time and providing the consumer information and sentiments to the marketing campaign system 310.

The real-time tracking system 316 comprises one or more computers or virtual machines, and is configured to execute program code stored in one or more computer-readable media to execute one or more methods according to this disclosure. In addition, the real-time tracking system 316 includes one or more network or communications interfaces for communicating with one or more other computer systems, devices, or networks. The real-time tracking system 316 is in communication with the one or more tools 112 of the marketing system 310. In addition, the real-time tracking system 316 is in communication with one or more networks, including network 350. In some embodiments, the real-time tracking system 316 may comprise, or be in communication with, one or more user interface devices, such as a keyboard, mouse, monitor, touch-sensitive input device, touch screen, or other user interface device.

In addition, in the embodiment shown in FIG. 3A, the real time tracking system 316 comprises a sentiment engine. As discussed above, a sentiment engine includes a software application (or applications) that is configured to calculate sentiments of expressions that have been provided to the sentiment engine. As shown in FIG. 3A, the sentiment engine may be a part of the real time tracking system 316 or may execute on one or more computer systems configured to execute the real time tracking system. However, in some embodiments, the sentiment engine 318 may be a separate component in communication with the marketing system 310. For example, FIG. 3B shows one embodiment of a marketing system 310 comprising a sentiment engine 318 that is in communication with the other components of the marketing system, including the one or more tools 112, which can be hosted by a computing system configured to execute the various tools 112-1 to 112-4 as well as the real time tracking system 316 and the data store 114. In some embodiments, the real time tracking system 316 or one or more of the tools 112-1 to 112-4 may employ, such as by invoking, the sentiment engine 318, such as by providing one or more sets of data to the sentiment engine 318 for sentiment analysis. For example, the real-time tracking system 316 may be configured to provide one or more user comments to the sentiment engine 318 that have been received from the one or more social media sites 360, 370.

In some exemplary embodiments, the marketing system 310 also may be in communication with a plurality of social media Internet sites, such as Facebook® 360 and Twitter® 370, via network 350. In other embodiments the marketing system 310 may be in communication with additional or other social media Internet sites, such as Instagram®, MySpace®, Snapchat®, Google+®, or others. The social media Internet sites 360, 370 may be in communication with one or more data stores 362, 372 that store comments, pictures, video, apps, or other content provided by the social media site itself or by one or more users of the site. In some embodiments, one or more social media Internet sites 360, 370 provide one or more application programming interfaces (APIs) to enable third parties to access and retrieve information from the social media sites 360, 370, such as individual comments, statistical information about comments or keywords, likes, or other user-generated content, including images and video. Facebook® has a Keyword Insights API for obtaining statistical information about identified keywords and its Public Feed API for obtaining user comments containing identified keywords. Twitter® has a similar set of APIs available, and other social media sites are expected to provide or are already providing similar APIs.

In an embodiment, the real-time tracking system 316 is configured to track sentiment information from both Facebook® and Twitter® to assist with generating qualified leads for a marketing campaign, for selecting one or more sets of target populations of leads, and for generating marketing materials to be sent to the target population. For example, a marketer employing tracked results may determine that a marketing campaign directed to the “Note 3” and with a focus on its “camera” may be best targeted towards consumers in the 13-34 year old age range as 75% of the comments posted on Facebook® regarding the Note 3's camera are from this age range, irrespective of gender. However, if the real-time tracking system 316 transmits a different query, the results may indicate a different consumer group should be targeted. For example, a query such as “SELECT age_gender_results FROM keyword insights WHERE term=‘Note 3’ AND term=‘handwriting’ AND country=‘US’ since yesterday” may return the following results:

“data”: [ {
“age_gender_results”: {
“gender”: {
“female”: 15823,
“male”: 13510
},
“user_age”: {
“13-17”: 954
“18-24”: 2169
“25-34”: 4761
“35-44”: 6633
“45-54”: 8312
“55+”: 6504
}}}}}

In such a case, a marketing system 310 may target a consumer population having an age of 35 years or older, irrespective of gender.

In the embodiment shown in FIG. 3A, the marketing system 310 includes the same or similar components of the marketing system 110 shown in FIG. 1, but also includes the real-time tracking system 316. Other embodiments may comprise alternative configurations. For example, in the embodiment shown in FIG. 3, the real-time tracking system 316 is defined within a software module separate from, but interfaced with the remainder of the marketing system 310, including marketing system tools 112 and the data store 114. In other embodiments, the real-time tracking system 316 may be entirely separate from the marketing system 310. FIG. 3C shows one such embodiment.

In the embodiment shown in FIG. 3C, the marketing system 310 is separate from the real-time capture and storage system 380, which includes a real-time tracking system 316 and a real-time storage system 382. In such an embodiment, the real-time capture and storage system 380 may be operated by a different entity than the entity that operates the marketing system 310. For example, a data analytics company may operate a real-time capture and storage system 380 and provide access, such as through a subscription service, to a marketing organization. The marketing organization's marketing system 310 may then request information from the real-time capture and storage system 380, such as for use in planning, executing, or tracking a marketing campaign. Still further configurations are contemplated within the scope of this disclosure.

Example Methods

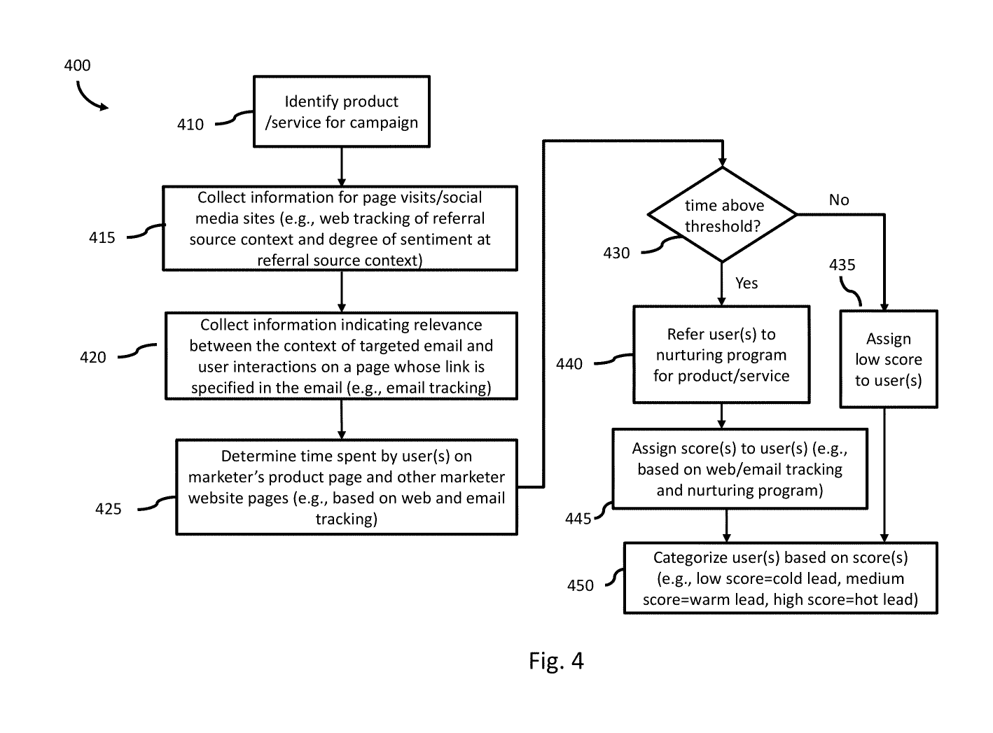

Embodiments provide intelligent scoring rules that result in high quality leads being generated. Steps of an example method are described below with reference to FIG. 4.

FIG. 4 is a flowchart of a method 400 according to certain exemplary embodiments. FIG. 4 is described with respect to a software application executed by the system 310 shown in FIG. 3A; however, the methods disclosed herein are not limited to execution by only the system 310 shown in FIG. 3A, but rather may be executed by any suitable system according to this disclosure. In addition, the method 400 of FIG. 4 will be discussed with respect to marketing a product having certain features and identifying qualified leads/prospects for that product. The blocks of the method 400 do not necessarily have to occur in the order shown in FIG. 4 and described below. According to embodiments, some of the blocks shown in FIG. 4 can be optional.

The method 400 begins in block 410 when a marketer uses a marketing system to identify a target product or service for a marketing campaign. For example, a marketer user may employ a marketing system 310 to plan a new marketing campaign. To do so, the user may employ a planning tool 112-1 to select a product, or multiple products, for the marketing campaign from an available pool of products, such as in a drop-down menu list or from a group of icons representing available products. In some embodiments, a planning tool 112-1 may receive information from an external system, such as in an electronic file, that identifies one or more products for a marketing campaign.

In some embodiments, the identified product may have associated information stored within the marketing system 310, such as information about one or more features of the product, on-sale dates for the product, available marketing offers for the product (e.g., rebates or coupons), or other relevant information. In one such embodiment, identifying the product includes identifying one or more features of the product. For example, if a user of the marketing system 310 uses a planning tool 112-1 to identify a product or products for a marketing campaign, she may also select one or more features or associated keywords of the identified product to incorporate into the marketing campaign. For example, if the user selects a smartphone product, she may also select one or more keywords associated with features of the product, such as smartphone camera's “image sensor resolution,” “low light capabilities,” or “video recording capabilities,” to incorporate into the marketing campaign.

In response to identifying a target product, the marketing system 310 in this embodiment may store the identified target product (or products), as well as any identified features of the target product as a part of the marketing campaign. For example, the user may use the planning tool 112-1 to create a new marketing campaign and the target product may be associated with the new marketing campaign, such as by saving a configuration file for the marketing campaign or by storing an association between the new marketing campaign and the target product in the data store 114.

In the embodiment shown in FIG. 4, after a target product or service has been identified, the method proceeds to block 415.

Web Tracking

In block 415, information is collected for page visits and social media site interaction. As shown, block 415 can comprise web tracking of referral source context and degree of sentiment at referral source context. Block 415 can comprise executing the real-time tracking system 316 to request and receive web tracking information from page visits and one or more social media sites 360, 370, where the information is associated with user comments about the target product. For example, after the user has identified the target product in block 410, the planning tool 112-1 may communicate with the real-time tracking system 316 to provide information about the target product (or products), including any identified features of the target product(s). In some embodiments, the planning tool 112-1 may also seek additional information from the user, such as an identification of one or more social media sites 360, 370. However, in some embodiments, the real-time tracking system 316 may be pre-configured to communicate with one or more social media sites 360, 370.

Web tracking performed at block 415 can include a referral source context and sentiment as part of a web tracking rule. In this way, for every page visit, the score that would be assigned to the prospect is a function of the value specified by the marketer as well as the referral source context and sentiment. For example, a score can be calculated using the following function and parameters:

Assigned Score=function (Value Specified, Amount of Referral Source Context, Degree of Sentiment at Referral Source Context).

Where, Value Specified is the score value as specified by the marketer. In an embodiment, a marketer can be an e-commerce webpage owner that indicates that a set/fixed score is to be assigned to each visitor to their page. In one embodiment, this can be used when the referrer/source page context is unavailable for a user visiting the marketer's page, and as a result, a default score is assigned to the user.

Amount of Referral Source Context is the amount of information at the source that is relevant to the marketer's product web page.

Degree of Referral Source Sentiment is the amount of positive sentiment at the source corresponding to the content of the marketer's product web page.

The following is an example of how an amount of referral source context and a degree of sentiment at referral source context can be calculated. First, an embodiment passes the content of the marketer's web page through a text/content analysis engine, such as, for example, Adobe® Sedona or a comparable natural language processing (NLP) engine such as the Natural Language Toolkit (NLTK).

Then, the embodiment performs ‘part of speech’ (POS) Tagging to generate the keywords K_T representing the gist of the web page. e.g., for a Samsung™ Note 3 page, keywords can be “Samsung™”, “Note 3”, “camera”, “display”, “battery” etc. These keywords can identify important features of the target product.

Next, the embodiment finds the referral source content ‘R_C’ as follows:

i. Clicked product ad that is placed alongside search results—find the displayed content of all search results near ad

ii. Clicked product ad that is placed on marketer's brand page or other public social forums—find the content and comments of the page near the ad.

iii. Clicked product ad placed on third party review sites—find the content of the third party review site.

The steps below describe how the amount of referral context can be calculated, according to an embodiment:

i. Find all keywords in K_T which are found in R_C and also find normalized term frequency of all such keywords. For example, R_C may talk about or mention “Camera” and “Battery” features of a product (e.g., a smartphone such as the Note 3), but does not talk about a “display” feature of the product. Since every R_C is different in length, it is possible that a term would appear many more times in long content than shorter ones. Thus, the term frequency is often divided by the content length (aka. the total number of terms in the content) as a way of normalization: Normalized Term Frequency(t)=(Number of times term t appears in a content)/(Total number of terms in the content).

ii. Amount of Referral Source Context is proportional to the number of keywords found in source referral content/Total number of keywords in K_T and the Normalized Term Frequency of the keywords found in source referral content.

In an embodiment, the Degree of sentiment at referral source context can be calculated using the following steps:

i. Find the sentiment of keywords in K_T which are found in content R_C by passing the content R_C though a “keyword-level sentiment engine” (A keyword-level sentiment engine is capable of finding the sentiment associated with particular keyword in given content).

ii. Then, calculate the overall sentiment of R_C towards marketer's web page by taking a weighted average of sentiment of keywords in K_T which are found in content R_C.

After receiving information about the target product(s) and any identified features of the target product(s), the real-time tracking system 316 generates and transmits a request to one or more social media sites 360, 370 for web tracking information associated with user comments about the target product. For example, in one embodiment, the real-time tracking system 316 may generate and transmit a message to an API for a social media site 360, 370. Such requests may be formatted according to the API for the social media site, and may include information about the target product(s), the identified feature(s), and other information provided by the planning tool 112-1 or the user. For example, the user may elect to seek information about a particular demographic group, such as all females between the ages of 13-34. In such an embodiment, the real-time tracking system 316 may transmit a web tracking request that identifies at least the demographic information. In some embodiments, however, the real-time tracking system 316 may not identify the identified demographic information in the query, but instead may filter information received from the social media site 360, 370 based on the particular demographic information.

After requesting the information from the social media site 360, 370, the real-time tracking system 316 receives web tracking information from the page visits and/or social media sites, the information is associated with user comments about the target product. For example, in one embodiment, the real-time tracking system 316 receives one or more files comprising copies of user comments about the target product. In another embodiment, the real-time tracking system 316 receives statistical information regarding comments about the target product. For example, in the embodiment discussed above, a real-time tracking system 316 may receive statistical information about the demographic groups' comments about a target product. Some embodiments may provide sentiment information regarding the target product. In some embodiments, the real-time tracking system 316 may identify the type of information to be received, such as copies of the user comments or statistical information. Alternatively, the information received from the social media site(s) 360, 370 may include a combination of different types of information, such as copies of user comments, statistical information, sentiment information, or other types of information made available by a social media site 360, 370, such as through one or more APIs.

In additional or alternative embodiments, the web tracking at block 415 can be implemented as described in the following paragraphs.

An option can be provided to the marketer to include the referral source context and sentiment in a web tracking scoring rule. According to this rule, for every page visit, the score that would be assigned to the prospect is a function of the value specified by the marketer as well as the referral source context and sentiment. For example the user can be assigned a score using the following rule: Assigned Score=function (Value Specified, Amount of Referral Source Context, Degree of Sentiment at Referral Source Context).

In another example, a new scoring rule could be: Assigned Score=Value Specified*(2*Degree of Sentiment at Referral Source Context)*(1+Amount of Referral Source Context)

Content ‘C_T’ of the target Page can be passed through a text/content analysis engine such as Adobe® Sedona or another Natural Language Processing (NLP) Engine, such as, for example, NLTK. POS Tagging can be performed on the content ‘C_T’ to generate the keywords vector ‘K_T’ (which represents the gist of the webpage by keeping only the important words like nouns, proper nouns etc. and removing pronouns, articles etc.). For example, for a Samsung Galaxy S5 page, K_T will have keywords like {“Samsung”, “camera”, “display”, “performance”, “battery”, “S-Health” . . . etc.}

In an alternate or additional embodiment, a marketer can himself provide a list of important keywords for the target page.

Next, block 415 can comprise identifying the source ‘S’ from where the visitor came. The source can be either of the following:

i. Referring site/page ‘S_RP’

ii. Search Engine Referral ‘S_SE’

iii. Social Channel Referral ‘S_SC’

At this point, block 415 can determine the source content ‘C_S’ as follows:

i. For source as S_RP, it is the content corresponding to the source page from where the visitor came. As an advanced option, it can be the content on the source page from the beginning of the page until the link to the target page/site which visitor clicked to reach the target page/site. This is because it is safe to assume that a user would have read only content till there on the source page before he came to the target site.

ii. For source as S_SC, it is the content corresponding to the source page from where the visitor came.

iii. For source as S_SE, it is the content corresponding to the search results description in the vicinity of the ad.

Next, block 415 can pass the source content ‘C_S’ through an NLP engine like NLTK and for every keyword in the vector ‘K_T’, determine the normalized term frequency ‘F_K_T_i’ in the source content ‘C_S’, and then store in the term frequency vector ‘F_K_T’. For keywords whose normalized term frequency is 0, the corresponding keywords were not present in the source content ‘C_S’ and therefore, user has not read about them. For keywords whose normalized term frequency is >0, the corresponding keywords were present in the source content ‘C_S’ and therefore, so the user has some context about them. The amount of context that user has about a particular keyword can be proportional to its normalized term frequency.

Next, block 415 can comprise finding the amount of referral context as follows:

$$Amount of Referral Context = {\sum }^{N} F\_K \_T \_i / N$$

Where, N is the number of elements in K_T. For every keyword ‘K_T_i’ in the vector ‘K_T’, block 415 can determine the sentiment in the source content ‘C_S’ and store in the sentiment vector ‘S_K_T’ as follows:

i. If ‘F_K_T_i’ is 0, set ‘S_K_T_i’ to −1 (invalid)

ii. b. If ‘F_K_T_i’>0, using a keyword level sentiment engine (such as, for example, AlchemyAPI), determine the sentiment score of ‘K_T_i’ and store in ‘S_K_T_i’

Then, find the degree of sentiment at the referral source context as follows:

$$Degree of Sentiment = {\sum }_{i = 0}^{N} ( F\_K \_T {\_i}^{*} S\_K \_T \_i ) {\sum }_{i = 0}^{N} F\_K \_T \_i$$

After receiving the web tracking information from the page visits and/or social media sites 360, 370, the method 400 continues to block 420.

Marketing Communications Tracking (e.g., Email Tracking)

At block 420, information is collected indicating relevance between the context of marketing communications, such as, for example, a targeted email message, and user interactions on a page whose link is specified in the email. As shown in FIG. 4, block 420 can include email tracking. In some embodiments, at block 420, the email tracking can be performed as described below.

Block 420 can comprise email tracking as discussed in the following paragraphs. For example, according to an embodiment, for every link in an email that is selected/clicked by a user, a method can evaluate and track that user's interaction with the sites linked to by the email. Further, for example one user who clicked on a Samsung™ Note link in an email, but then read information regarding Samsung™ washing machines at the linked to site will get a lower score than a 2nd user who goes to the site then reads info re: the Samsung™ Note phone (e.g., views demo video, reads specs, reviews, et al.).

Email tracking can include relevance between the context of the targeted email and the interactions done on the web page whose link is specified in email in the email tracking rule. This will ensure that for every link clicked, the score that would be assigned to the prospect is a function of the value specified by the marketer as well as the relevance between the context of the email and the interactions done on the web page whose link is specified in the email.

Assigned Score=function(Value Specified, Relevance between the context of the targeted email and the interactions done on the web page whose link is specified in the email.

The following paragraphs provide an example of how the relevance between the context of the targeted email and the interactions done on the web page whose link is specified in email can be calculated:

a. Find the keywords K_S which represents important keywords (product features) in the email in which user clicked the link

b. A user clicks on the link in the email to visit marketer's product page. After that, the user may continue to explore other products on the marketer's site. Hence, an embodiment can find following:

i. Time spent on the marketer's product page (referred to herein as T_M_P).

ii. Time spent on other pages on marketer's website. Such time is referred to herein as T_O_P(j). That is, T_O_P=time spent on other pages.

For every other page on which user has spent time above a threshold value (in one example, this threshold can be set by marketers, e.g., above average time spent by users), do the following:

i. Pass the content of that page through an entity and category detection engine.

ii. Entity Detection will find out the product corresponding to this page and theme detection will find out important keywords (features) of this product.

iii. If the entities mentioned in this page and theme of this page matches with marketer's product page. Add the time spend on this page to the time spend on marketer's product page.

T_M_P=T_M_P+ΣT_O_Pj=nj=1 (for all j where theme and entities matches with marketer's product).

As described with reference to blocks 430 and 435 below, if T_M_P is below a threshold (in one embodiment, this threshold can be based on analytics data, such as, for example, average T_M_P known by marketer), assign a low score to this user as the relevance between the context of the targeted email and the interactions done on the web page whose link is specified in email is less.

Otherwise, as shown in block 440, if T_O_P is much above a threshold, identify all T_O_Ps whose entities and theme broadly matches and merge them. After this merging, an embodiment will have time spent by the user on other category of products. If this time is above the threshold, as shown in block 440, refer these users to nurturing program of the corresponding products.

Embodiments collect source/referrer page context and sentiment, not just a link or URL of a source page. Sentiment cannot be collected after the fact because the contents of the source page changes. An embodiment can include a graphical user interface (UI) presented to marketer, with checkboxes for using a static score, or using source sentiment, or using source context.

Natural Language processing can be used in example embodiments to do following: (1) An “n-gram POS (part of speech) tagger” trained on the brand's content can easily identify important keywords (features) in the marketer's product ad/landing page/product email.

For this, embodiments can use the ‘Statistical Autotagger/summarizer’ provided by Adobe® Sedona to identify keywords.

Additional or alternative embodiments can also use the Natural Language Toolkit (NLTK) part of speech (POS) tagging for the same purpose. Outlined below is an example text mining approach that embodiments can use to identify important keywords in marketer's product ad/product landing page/product email using NLTK.

Given the URL of a page, an embodiment can get the text out of this HTML using “raw=nitk.clean_html( )”, which takes an HTML string and returns raw text. More sophisticated processing of HTML can be done using HTML processing packages, such as, for example, the Beautiful Soup package.

The HTML processing can be performed on raw text that is available from an HTML page. An embodiment can then tokenize this raw text using “tokens=nitk.word_tokenize (raw)”

Next, block 420 can convert tokenized text to lower case using “words=[w.lower( ) for w in tokens].”

Then, an embodiment can do stemming, which is a process for finding stems of the words. NLTK offers two stemmers, Porter and Lancaster. An embodiment can use both. For example, the following script can be used:

porter=nitk.PorterStemmer( )

lancaster=nitk.LancasterStemmer( )

stemedwords_first_pass=[porter.stem(t) for t in words] stemedwords_final_pass=[lancaster.stem(t) for t in stemedwords_first_pass]

Next, an embodiment can do lemmatization, which is a process of grouping together the different inflected forms of a word so they can be analyzed as a single item. As would be understood by one skilled in the relevant art, lemmatization is an algorithmic process of determining the lemma for a given word. Since the lemmatization process may involve complex tasks such as, for example, understanding context and determining the part of speech of a word in a sentence (which can require, for example, knowledge of the grammar of a language), it can be complex to implement a lemmatizer for a new language.

In one embodiment, lemmatization can be performed as follows:

wnl=nitk.WordNetLemmatizer( )

completely_normalized_words=[wnl.lemmatize(t) for t in

stemedwords_final_pass]

Then, an embodiment can do POS tagging. The process of classifying words into their parts of speech and labeling them accordingly is known as part-of-speech tagging, POS-tagging, or simply tagging. After POS tagging, the process will know whether a word is a Noun, Proper Noun, Verb, Adjective, Pronoun, article etc. In one embodiment, POS tagging is expressed as:

pos_tagged_words=nitk.pos_tag(completely_normalized_words)

Embodiments can determine nouns and proper nouns (e.g., Camera, Battery, S-Health, Display, etc.) on a web page. The determining can include determining nouns and proper nouns that are of interest to a marketer. Nouns and proper nouns will assist with identifying all the subjects which this particular text talks about. Hence, an embodiment can figure out Nouns/Proper Nouns in order of their frequency in the normalized text.

In a non-limiting example, the following script can be used to perform normalization and Part of Speech (POS) Tagging:

import nltk
import urllib
#read url, clean it and tokenize
url = “WRITE URL HERE”
html = urllib.urlopen(url).read( )
raw = nltk.clean_html(html) #clean this URL to get raw text
#Normalization Starts
tokens = nltk.word_tokenize(raw)
words = [w.lower( ) for w in tokens]
porter = nltk.PorterStemmer( )
lancaster = nltk.LancasterStemmer( )
stemedwords_first_pass = [porter.stem(t) for t in words]
stemedwords_final_pass = [lancaster.stem(t) for t in
stemedwords_first_pass]
wnl = nltk.WordNetLemmatizer( )
completely_normalized_words = [wnl.lemmatize(t) for t in
stemedwords_final_pass]
#Normalization Ends, Part of Speech Tagging starts
pos_tagged_words = nltk.pos_tag(completely_normalized_words)
#Extract Nouns and Proper Nouns in order of their frequency
myDict = dict( )
for key, val in sorted(pos_tagged_words):
if((val == ‘NNP’ or val == ‘NN’) and len(key) > 3):
if(myDict.has_key(key) == False):
myDict[key] = 1
else:
myDict[key] = (myDict.get(key) + 1)
for word in sorted(myDict, key=myDict.get, reverse=True):
if(myDict.get(word) > 0):
print word + “:”, myDict.get(word) #Print nouns/proper nouns whose
occurrence isatleast once

(2) For referring third party review pages, search engine results and Facebook® Brand Pages/Public Forums, an embodiment may just have to calculate the frequency of important keywords corresponding to marketer's product keywords/features in referring content. For this an embodiment can just change last step of the above mentioned NLTK script and pass the content and run this script on source referring page.
#check if source referring page has words like camera, battery, display, s-health etc. for word in sorted(myDict, key=myDict.get, reverse=True):
if(myDict.get(word)>0 and word in (‘camera’, ‘battery’, ‘display’, ‘s-health’)):
print word+“:”, myDict.get(word) #print word and is frequency

In additional or alternative embodiments, the email tracking at block 420 can be implemented as described in the following paragraphs.

An option can be provided to a marketer to include the relevance between the context of the targeted email and the interactions done on the web page whose link is specified in the email in an email tracking scoring rule so that for every link clicked, the score that would be assigned to the prospect is a function of the value specified by the marketer as well as the relevance between the email and the interactions done on the target web page.

One scoring rule can be expressed as: Assigned Score=function (Value Specified, Relevance between the context of the targeted email and the interactions done on the web page whose link is specified in email).

For example, an alternative scoring rule could be expressed as: Assigned Score=Value Specified*(1+Relevance between the context of the targeted email and the interactions done on the web page whose link is specified in email).

Content ‘C_S’ of the email can be passed through a text/content analysis engine like Adobe® Sedona or any other Natural Language Processing (NLP) Engine like NLTK. POS Tagging can then be performed on the content ‘C_S’ to generate the keywords vector ‘K_S’ (which represents the gist of the email by keeping only the important words like nouns, proper nouns etc. and removing pronouns, articles etc.)

When a user clicks on the link in the email to visit marketer's product page, track the pages ‘S_P’ visited by the user along with the time spent ‘S_P_T’ on each page.

Then, find the entity ‘E’ corresponding to the web page pointed by the link in the email. Next, initialize ‘T_R’ (time spent on relevant web pages) to 0 and initialize ‘T_O’ (time spent on other (not relevant to the email content) web pages) to 0.

At this point, for every page ‘S_P_i’ visited by the user:

i. If the time spent ‘S_P_T_i’ is above a threshold value, go to the next step.

ii. Pass the content ‘S_P_i_C’ through an entity and category detection engine to find the entity (product) ‘S_P_i_E’ and category (features) ‘S_P_i_C’ corresponding to the web page.

iii. If entity mentioned in this page ‘S_P_i_E’ matches with that of the target web page specified in the email ‘E’

T_R=T_R+S_P_T_i

Otherwise, T_O=T_O+S_P_T_i

Then, find the relevance ‘R’ as T_R/T_T where T_T is the threshold time that marketer expects the user to spend on the target site. Relevance between the context of the targeted email and the interactions done on the web page whose link is specified in email=R if R<1, 1 otherwise.

If T_O is above a threshold:

i. Identify all S_P_i whose entities matches and merge them to create S_{—} M and S_M_T.

ii. For every element S_M_i in S_M whose entity is different from ‘E’ and S_M_T_i is above the threshold, refer these users to nurturing program of the corresponding products.

After email tracking information is collected at block 420, control is passed to block 425.

At block 425, the time spent by users on the marketer's product page and other marketer website pages is determined. As shown in FIG. 4, this determination can be based at least in part on the web and email tracking performed at blocks 415 and 420, respectively.

Next, at block 430, a determination is made as to whether the time spent by users on the marketer's product page and other pages exceeds a predetermined threshold. If it is determined that the time exceeds the threshold, control is passed to block 440 where the user is referred to a nurturing program. Otherwise, control is passed to block 435, where a low score is assigned to the user.

At block 445, scores are assigned to users. As shown in FIG. 4, the scores can be based on web/email tracking and results of the nurturing program.

Then, at block 450, the users are categorized based on scores assigned at blocks 435 and 445. In the example of FIG. 4, a low score results in the user being categorized as a cold lead, a medium score results in the user being categorized as a warm lead, and a high score results in the user being categorized as a hot lead.

Example Sentiment Engine Outputs and Interfaces

In an embodiment, keyword level sentiment analysis can be performed by a keyword level sentiment engine that provides the ability to extract keyword-level sentiment. One example sentiment engine is the AlchemyAPI, which has the capability of extracting keyword-level sentiment. For example, the Adobe® Phoenix and Sentiment Analysis Engine can be used in some embodiments. Such an engine may be configured to detect, extract, and weight sentence affect and sentiment signal using a general purpose sentiment vocabulary combined with a NLP engine. It can use as input POS and NX/VX tagged sentences, and then determine and score the positive, negative, and neutral sentiment.

FIG. 5 depicts an example where an online customer acquisition program has been launched for a recently introduced smartphone. The customer acquisition program is launched to capture details of all potential customers who are evaluating or searching for that specific smartphone. An example of an ad placed as part of such an acquisition program is depicted in search results 500 shown in FIG. 5. As shown, when a user searches for the search term “Galaxy note 3 reviews” using a search engine, an acquisition program can present a Samsung™ Galaxy Note 3 ad in side bar as part of search results 500.

When the user clicks on this ad, he will be taken to a ‘Galaxy Note 3’ landing page. On this page, the user can learn more about the product and can also fill a form to express his interest in a ‘10% off offer’ on this smartphone. Also, this user who is coming after clicking this ad in search results 500 has probably looked at the exemplary text displayed in the search results 500 alongside the ad: ‘The Note remains unchallenged in its category. Great battery life, a brilliant display and top performance make it an excellent all-round . . . ’ In the example of FIG. 5, this user will have the following immediate context/mindset: he has read about battery, display and performance, and his mindset for these features is positive. If the immediate feeling/context of the user is highly positive towards marketer products or services, the user is assigned a higher score so as to route him to sales team at the earliest and make him convert thereby capitalizing on the positive sentiment in the mind of the customer.

Example output 520 from a sentiment engine, resulting from an example search result 500 is provided in FIG. 5. In the example of FIG. 5, a user searched for a search term “galaxy note 3 reviews” and the search results 500 include a few search results and an ad for a Samsung™ Galaxy Note 3. As shown in FIG. 5, the text displayed in the search result 500 alongside the ad is: “The Note remains unchallenged in its category. Great battery life, a brilliant display and top performance make it an excellent all-rounder f . . . ” As seen in the sentiment engine output 520, a conclusion can be drawn that any user who reads search result 500 will have positive sentiment towards battery, display and performance of the Note 3 product.

Embodiments use a sentiment analysis engine. One non-limiting example of such a sentiment analysis engine is Adobe® Sammy/Semantria. A sentiment analysis engine can be used in certain embodiments to determine the overall sentiment of a given piece of content. For example FIG. 6 provides an example output of a sentiment engine.

FIG. 6 provides an example of a positive social media (e.g., Facebook®) post 600 by a user of a Samsung™ Galaxy S5 along with the corresponding output 620 of a sentiment engine. As shown in output 620, the sentiment engine has classified post 600 as positive. In particular, FIG. 6 shows a post 600 from a Facebook® user who has posted following highly positive comment for ‘Samsung™ Galaxy S5’ and the producer's team (e.g., a Samsung™ representative) replied back to this user thanking her. If a second user comes to a Galaxy S5 site by clicking on the link mentioned in this conversation, then an embodiment will assign a higher score to this visit by the second user. This is done in order to route this second user to a sales team at the earliest convenience so as to convert the second user to a customer, thereby capitalizing on the positive sentiment in the mind of this potential customer/purchaser.

FIG. 7 shows sentiment 710 included in an example search results 700. In particular, FIG. 7 shows the result of a user's search for the term low light note 3 camera′ and how this user is presented with a few search results 700 and an ad for a corresponding product (e.g., a Samsung™ Galaxy Note 3 smartphone). As shown, a first search result in results 700 indicates ‘Where the Note 3 really disappoints is its low-light performance.’ In this example, this user has the following immediate context/mindset: He is interested in the smartphone's camera, especially the camera's performance in low light conditions, and his mindset for these features is negative. Hence, given his interest and knowledge, an embodiment will assign a medium score to the user. The user can be referred to a nurturing program, where he can be given specific inputs featuring the phone's camera and the camera's low light performance.

FIG. 8 shows results 820 of text extraction and other data from an example product page 800. In the example of FIG. 8, a Diffbot Article API is used to extract clean article text 820 and other data from news articles, blog posts and other text-heavy pages, such as product page 800. The API retrieves the full-text, cleaned and normalized HTML, related images and videos, author, date, tags—all automatically, from any article on any site, such as page 800.

One embodiment uses this API to find the content of a given page 800 that user has visited on marketer's site. This is important because many html pages are quite complex and need to be parsed. FIG. 8 shows the example Input Link of a refrigerator product page 800 and Output 820 of Diffbot's Article API, which can extract the content of the page 800.

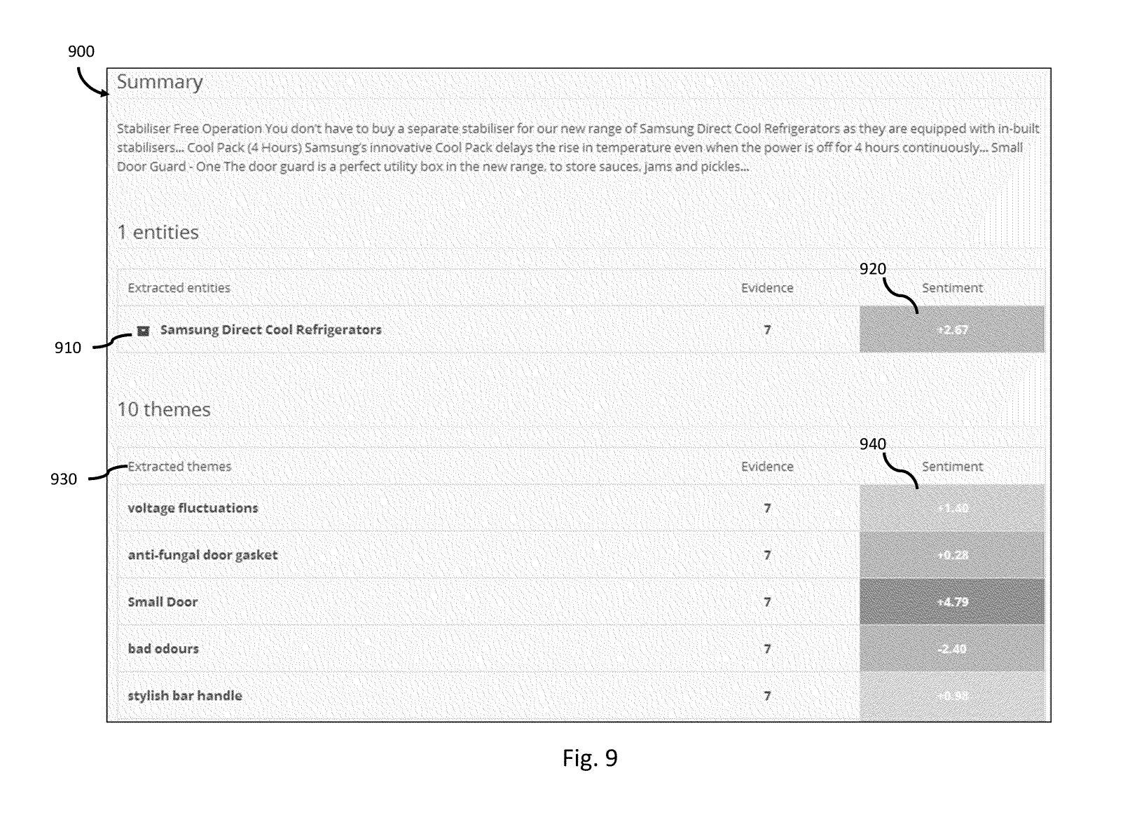

FIG. 9 shows the results of theme extraction 900 where an entity 910, sentiment for the entity 920, themes 930, and theme sentiment 940 have been extracted from an example product page. In particular, FIG. 9 provides an example of theme extraction 900 for a refrigerator product page. In an embodiment, named entity extraction (NER) can be used to automatically pull proper nouns from text, such as people, places, companies, brands, job titles and other proper nouns. Themes are noun phrases extracted from text and can be a means of identifying main ideas within electronic content, such as a product page. In an embodiment, NER can be used to assign a sentiment score to each extracted theme from a page, so that a marketer can understand a tone or sentiment behind the themes. In the example of FIG. 9, theme extraction results 900 are presented. Theme extraction extracts themes within a page's content so that a marketer can determine relevant entities and themes for a product page. Themes are noun phrases extracted from text and are the primary means of identifying the main ideas within your content. As shown, theme extraction results 900 have clearly found that the page's content talks about an entity 910, where entity 910 is a manufacturer's refrigerator. Entity 910 is identified using entity detection. Results 900 also include a list of multiple themes 930 identified by important keywords of the page such as “Voltage Fluctuations”, “Anti-fungal door gasket,” etc. As seen in FIG. 9, clearly these themes 930 as well as the entity 910 do not correspond to a smartphone or a mobile device. Thus, if a user is spending more time on this refrigerator page, the user will be assigned a lower score for smartphone leads, including any leads associated with specific phone models.

Example Processes

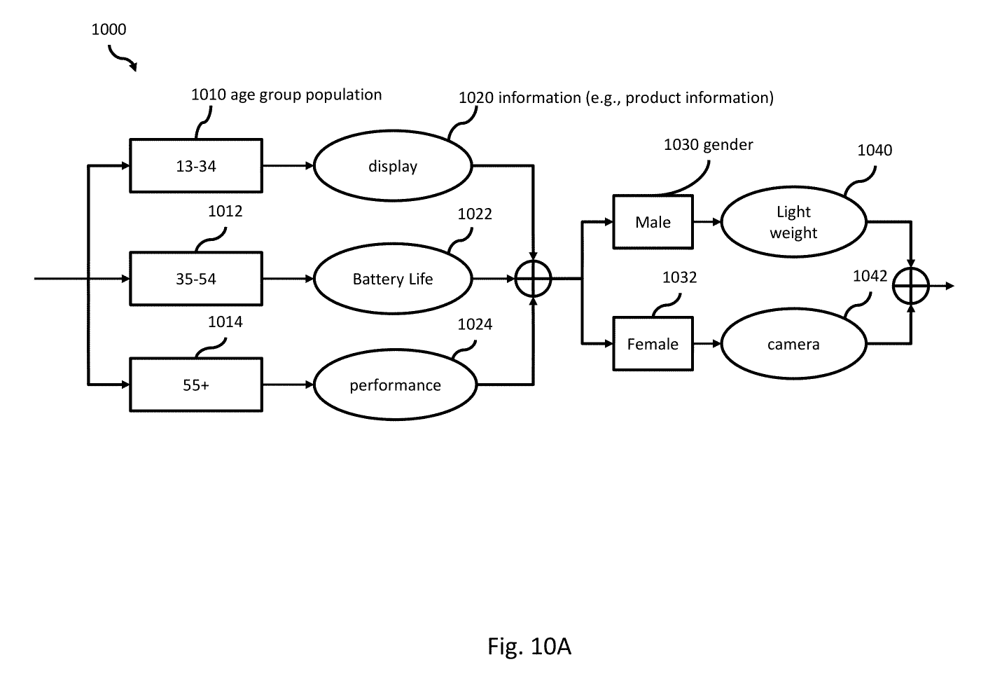

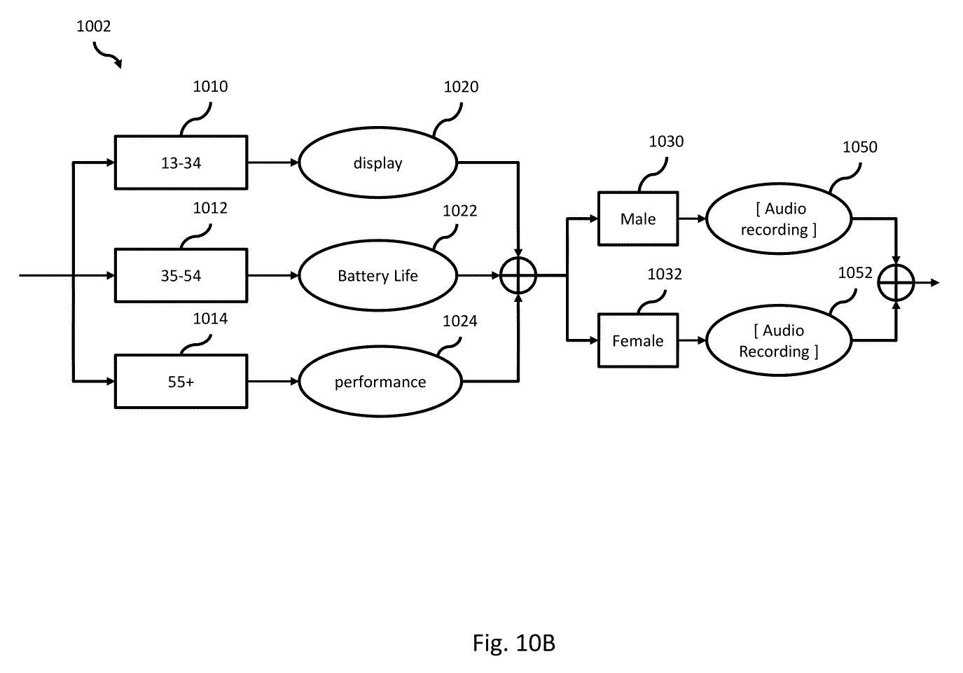

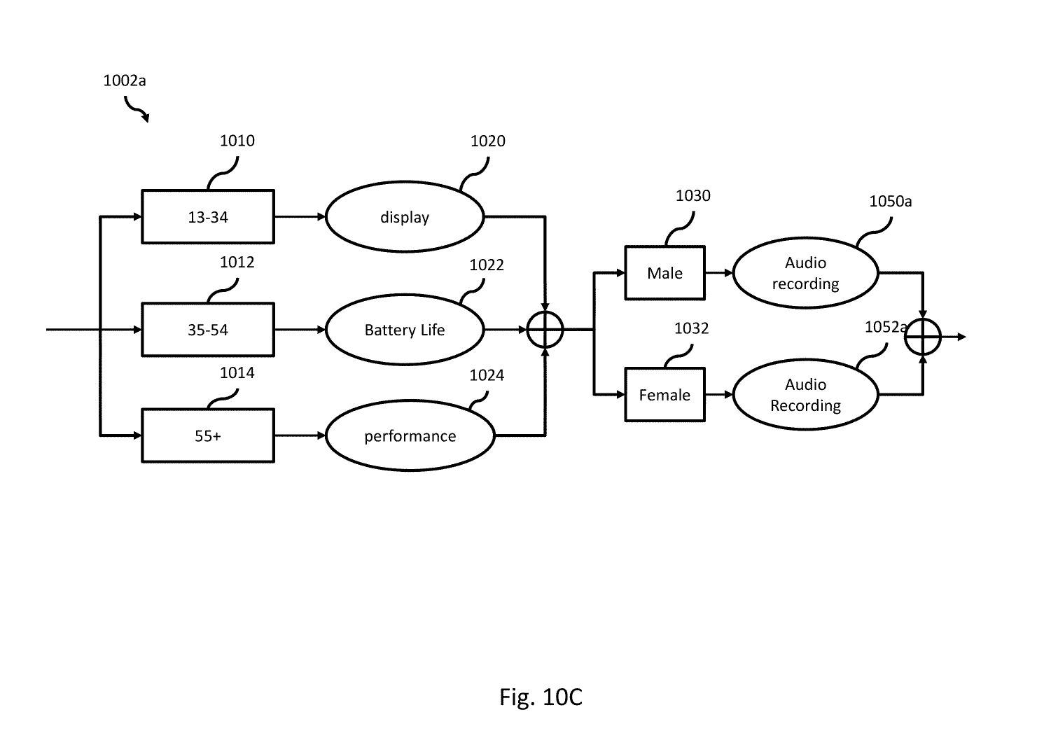

FIG. 10A shows a process flow 1000 for generating a marketing communication according to certain embodiments. According to embodiments, the marketing communication generated using process flow 1000 can be targeted to a highly qualified lead generated by method 400 described above with reference to FIG. 4. Also, when process flow 1000 is used to generate a marketing communication embodied as an email message, the email tracking techniques discussed above with reference to block 420 of FIG. 4 can be used to track the context of the email and user interactions on a page whose address or link is indicated in the email.

In the example shown in FIG. 10A, six target populations have been identified based on age and gender. According to this embodiment, the marketing system 310 is configured to generate email communications to be transmitted to the various target populations. To generate emails appropriate to each of the target populations, the marketing system 310 first determines for which age group to generate an email communication. In this embodiment, three age group populations 1010, 1012, 1014 have been generated by the marketing system 310. For purposes of this example, the marketing system 310 generates an email communication directed to 13-34 year-old females.

As the marketing system 310 generates an email communication for the first age group 1010 the marketing system 310 is provided with information 1020 indicating that the first age group 1010 has positively commented about the new smartphone product's display. Therefore, the marketing system 310 generates a subject line for the email communication that emphasizes the smartphone's display. The marketing system 310 then proceeds to the next attribute of the target population, the gender, and in this case, is generating an email communication to female consumers 1032. The marketing system 310 then determines that this target population 1032 has commented positively about battery life features of the new smartphone product, and updates the subject line for the email communication to add information about autofocus capabilities and incorporates content including, in this example, one or more URLs linked to dynamic content relating to the new smartphone product. After traversing the process flow 1000, the marketing system 310 has generated an email marketing communication to 13-34 year-old female consumers that emphasize two product features of interest to that demographic. The marketing system 310 will then traverse each of the potential paths of the process flow 1000 that are applicable to the target population for a marketing campaign. Thus, when generating marketing communications directed to consumers in the 35-54 year-old age group, the marketing system 310 in one embodiment will traverse block 1012 of the process flow 1000 and create a marketing communication with an email communication that emphasizes the battery life 1022 of the smartphone. It will then traverse the appropriate path based on gender, whether 1030 or 1032, to generate an appropriate marketing communication. Thus, by executing the process flow 1000, the marketing system 310 may generate up to six different types of marketing communications: one for each of the age groups 1010, 1012, and 1014, and for each age group, two different types based on gender 1030, 1032. For each targeted consumer, the marketing system 310 may then select the appropriate marketing communication for the respective consumer based on the consumer's age and gender. For example, for qualified leads in the 55 and above age group, the marketing system 310 will traverse block 1014 of the process flow 1000 and create a marketing email communication that emphasizes the low light performance 1024 of the smartphone's camera.

In this example, the product features having positive sentiment amongst the target population are incorporated into the subject of the email communication. Such a strategy may encourage more recipients of the communication to open the email as it places relevant, enticing information in a location that is likely to be viewed by the target population. In addition, the marketing system 310 incorporates additional product information into the body of the email communication, such as additional features of the product and one or more URLs that dynamically incorporate graphics or other information about the product, as well as one or more URLs to web pages at which to purchase the new product.

FIG. 10B shows another example process flow 1002 according to certain embodiments. In the process flow 1002 shown in FIG. 10B, the marketing system 310 again has multiple target populations and is similar to the process flow 1000 shown in FIG. 10A. However, in this example, terms having negative sentiment are incorporated into the process flow. In this embodiment, the “audio recording” term has a negative sentiment associated with it for both male and female target populations, with the negativity of the sentiment denoted by square brackets ([ ]). Thus, as the marketing system 310 processes the user information and sentiments to generate communications to the respective target populations, upon reaching blocks 1050 or 1052, the marketing system 310 will either remove content relating to an audio recording feature of the smartphone product from the communication, or will flag such content to be excluded from communications to be generated once the process flow has been completed. Thus, in some embodiments, the marketing system 310 is configured to emphasize features having associated positive sentiment and to deemphasize features having associated negative sentiment for the target population. In some embodiments, the marketing system 310 may entirely omit such features from a marketing communication, while in other embodiments, it may only include a brief mention of the feature in a feature list or otherwise deemphasize the feature. Thus, in some embodiments, the marketing system 310 may deemphasize, by omitting or reducing a relative emphasis of a feature to other features, or by increasing the emphasis on other features relative to the feature having the negative associated sentiment.

Also, in some embodiments, depending on the configuration of a process flow, certain features may have an associated positive sentiment for one target population but have an associated negative sentiment for a different target population. For example, a small size of a smartphone may have a positive associated sentiment for a younger female target population, but have a negative associated sentiment for an older male target population.

As discussed above with respect to FIG. 10A, the marketing system 310 will then traverse each of the potential paths of the process flow 1002 that are applicable to the target population for a marketing campaign. Thus, when generating marketing communications directed to qualified leads in the 35-54 year-old age group, the marketing system 310 in one embodiment will traverse block 1012 of the process flow 1000 and create a marketing communication with an email communication that emphasizes the battery life 1022 of the smartphone. It will then traverse the appropriate path based on gender, whether 1030 or 1032, to generate an appropriate marketing communication. Thus, by executing the process flow 1010, the marketing system 310 may generate up to six different types of marketing communications: one for each of the age groups 1010, 1012, and 1014, and for each age group, two different types based on gender 1030, 1032. For each targeted consumer (e.g., qualified lead), the marketing system 310 may then select the appropriate marketing communication for the respective consumer based on the consumer's age and gender.

In addition to the content to be viewed by the target population, in some embodiments the marketing system 310 also may embed tracking functionality into the email communication. Such information, such as URLs, may cause tracking information to be sent to the marketing system 310 upon the occurrence of certain activities. For example, some embodiments may incorporate tracking functionality into an email communication to send a notification to the marketing system 310 if the user opens the email communication. In some embodiments, the marketing system 310 may incorporate URLs to information websites or websites that sell the product, where these URLs include functionality to send tracking information to the marketing system 310 indicating that the consumer has clicked on one or more of the URLs. Further, these websites may incorporate additional tracking functionality to send tracking information to the marketing system 310 based on actions taken by the consumer on the respective website, including which links the user selects, whether the user purchase the product, whether the user purchases a competitor product, or whether the user cancels a purchase before completion.

In some of the embodiments discussed above, the marketing communication comprises an email communication. However, in some embodiments, other types of communications may be created and transmitted. As discussed above, in some embodiments, the marketing system 310 comprises a data store 114 that may include information regarding different consumers. Some of the stored information may include preference information regarding desired and disfavored forms of communication. For example, consumer profiles stored in a data store 114 may comprise information regarding the profiled consumers' preferences for email communications, postal mail communications, Tweets®, SMS or MMS messages, social media messages (e.g., Facebook® status updates or private messages), etc. Embodiments according to this disclosure may generate communications based on the target population's, or even individual targeted consumers′, preferences. In some embodiments, multiple different communications channels may be used simultaneously, or may reference each other. For example, in one embodiment, the marketing system 310 may generate an email message and a Facebook® message on the user's Facebook® timeline, where the email message provides a URL to Facebook® and a message to view a promotional offer available through Facebook®. Thus, the marketing system 310 may be configured to generate and transmit a wide variety of marketing communications.

After the marketing system 310 has generated and transmitted the communication, the method 400 proceeds to block 435.

In block 435, the marketing system 310 requests additional information from the one or more social media sites 360, 370, the additional information associated with user comments about the target product. In the example of FIG. 4, the marketing system 310 is configured to request additional information from the one or more social media sites 360, 370 from which information was requested in block 415. The additional information may comprise updated information in response to the marketing system 310 sending an identical request to the social media site 360, 370, or may be in response to different requests. In some embodiments, the request may be for only updated information, such as new statistical information during the time period between the previous request and the new request.

After the marketing system 310 requests the additional information, the method 400 proceeds to block 440.

In block 440, the marketing system 310 determines updated sentiments associated with the additional user comments about the target product. The marketing system 310 may be configured, according to some embodiments, to request additional information from the one or more social media sites 360, 370 to determine whether consumer sentiments regarding the target product have changed over time or if different features of the target product are the subject of comments. For example, in the example shown in FIG. 5, the audio recording quality of the target product had an associated negative sentiment. However, if the product is updated, such as via a software patch, to improve the audio recording quality of the target product, consumer sentiment regarding the feature may change. Thus, by requesting additional information from the one or more social media sites 360, 370, the marketing system 310 may be able to update a process flow, such as process flow 1002a shown in FIG. 10A, for generating and transmitting communications to the target population.

For example, referring to FIG. 10C, after requesting additional information from the one or more social media sites 360, 370, the marketing system 310 updates process flow 1002, shown in FIG. 10B, to create process flow 1002a. The process flow 1002a in FIG. 10C reflects a change in sentiment regarding the audio recording feature of the target product (a smartphone product). As may be seen in FIG. 10C, the audio recording feature 1050a, 1052a is now a feature to be emphasized, as indicated by the lack of square brackets found in the process flow 1002 of FIG. 10B. Thus, by requesting additional information from the one or more social media sites 360, 370, the marketing system 310 is able to dynamically alter sentiment information associated with the target product or features of the target product.

After the marketing system 310 determines updated sentiments, the method proceeds to block 445.

In block 445, the marketing system 310 generates and transmits updated marketing communications based on the additional information and the updated sentiments. As discussed above, the marketing system 310 can be configured to generate communications based on information received from social media websites 360, 370 as well as sentiment information generated based on the received information. Such information can be used to generate process flows, such as process flows 1000, 1002, 1002a shown in FIGS. 10A-C for generating communications to one or more target populations. Following the receipt of additional information and the determination of updated sentiment information, the marketing system 310 can generate and transmit communications based on this additional information and the updated sentiment information. For example, referring again to FIG. 10C, an updated process flow 1002a may be generated based on the updated sentiment information, and the marketing system according to one such embodiment generates and transmits communications based on the updated process flow 1002a. In this embodiment, the marketing system 310 employs the process flow 1002a in FIG. 10C as was discussed with respect to FIG. 10A or 10B.

For example, the marketing system 310 may be able to alter a targeted advertisement on Facebook® to emphasize a feature of product based on changed sentiment such that when a targeted consumer next logs into their Facebook® account, she may be presented with an updated communication that emphasizes the feature. Thus, it may be possible to present targeted consumers with relevant, targeted communications that reflect consumer sentiment and emphasize a target product, or features of a target product, to a relevant target population, in a communications channel of interest to that target population, and emphasizing (or deemphasizing) features of the target product according to the target population's determined sentiment towards the target product or feature(s).

Thus, in some embodiments, the marketing system 310 is able to dynamically alter a marketing campaign according to changing consumer sentiment about the target product or particular features of the target product. Such a system may provide a more effective mechanism for targeting an appropriate population and for providing more relevant and enticing marketing communications to that target population over time.

Example Computer System Implementation

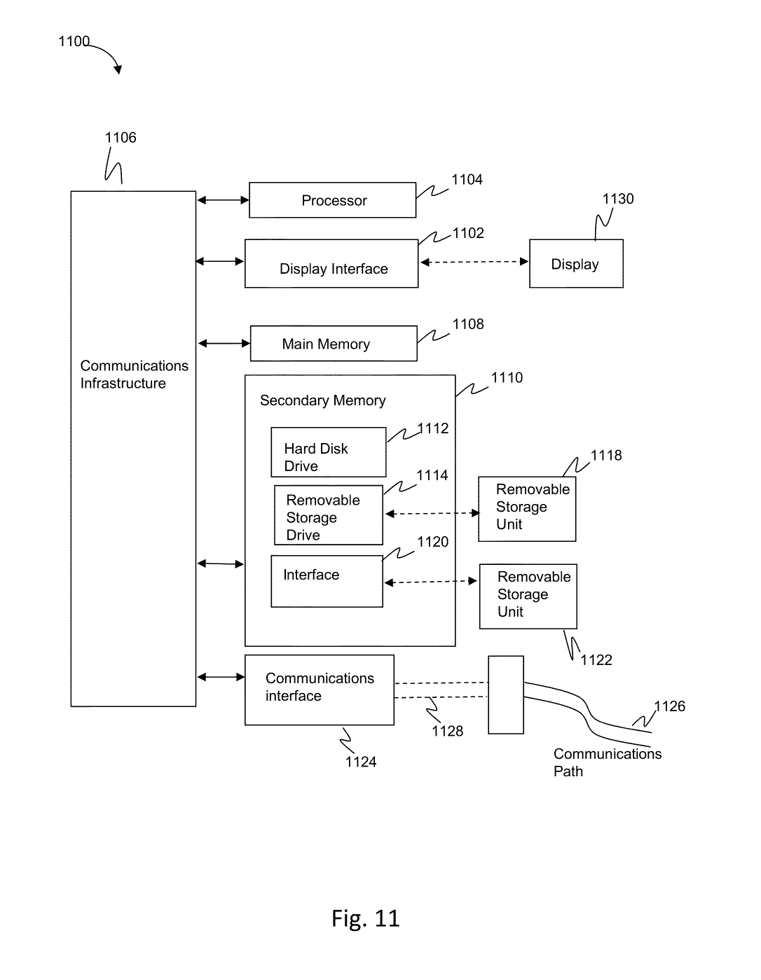

Although exemplary embodiments have been described in terms of charging apparatuses, units, systems, and methods, it is contemplated that certain functionality described herein may be implemented in software on microprocessors, such as a microprocessor chip included in the processors of marketing systems 110 and 310 and processor of tracking system 316 shown in FIGS. 1 and 3, and computing devices such as the computer system 1100 illustrated in FIG. 11. In various embodiments, one or more of the functions of the various components may be implemented in software that controls a computing device, such as computer system 1100, which is described below with reference to FIG. 11.

Aspects of the present invention shown in FIGS. 1-10, or any part(s) or function(s) thereof, may be implemented using hardware, software modules, firmware, tangible computer readable media having logic or instructions stored thereon, or a combination thereof and may be implemented in one or more computer systems or other processing systems.

FIG. 11 illustrates an example computer system 1100 in which embodiments of the present invention, or portions thereof, may be implemented as computer-readable instructions or code. For example, some functionality performed by the marketing systems 110 and 310 and their respective tools 112 and tracking system 316 shown in FIGS. 1-3, can be implemented in the computer system 1100 using hardware, software, firmware, non-transitory computer readable media having instructions stored thereon, or a combination thereof and may be implemented in one or more computer systems or other processing systems. Hardware, software, or any combination of such may embody certain modules and components used to implement blocks in the method 400 illustrated by the flowchart of FIG. 4 discussed above. Similarly, hardware, software, or any combination of such may embody the marketing systems 110 and 310 and their respective tools 112 and tracking system 316 discussed above with reference to FIGS. 1-3.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the invention are described in terms of this example computer system 1100. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1104 may be a special purpose or a general purpose processor device. As will be appreciated by persons skilled in the relevant art, processor device 1104 may also be a single processor in a multi-core/multiprocessor system, such system operating alone, or in a cluster of computing devices operating in a cluster or server farm. Processor device 1104 is connected to a communication infrastructure 1106, for example, a bus, message queue, network, or multi-core message-passing scheme. In certain embodiments, one or more processors of marketing systems 110 and 310 and their respective tools 112 and tracking system 316 described above with reference to FIGS. 1-3 can be embodied as the processor device 1104 shown in FIG. 11.

Computer system 1100 also includes a main memory 1108, for example, random access memory (RAM), and may also include a secondary memory 1110. Secondary memory 1110 may include, for example, a hard disk drive 1112, removable storage drive 1114. Removable storage drive 1114 may comprise a floppy disk drive, a magnetic tape drive, an optical disk drive, a flash memory, or the like. In non-limiting embodiments, one or more of the memories of marketing systems 110 and 310 and their respective tools 112 and tracking system 316 described above with reference to FIGS. 1-3 can be embodied as the main memory 1108 shown in FIG. 11.

The removable storage drive 1114 reads from and/or writes to a removable storage unit 1118 in a well known manner. Removable storage unit 1118 may comprise a floppy disk, magnetic tape, optical disk, etc. which is read by and written to by removable storage drive 1114. As will be appreciated by persons skilled in the relevant art, removable storage unit 1118 includes a non-transitory computer readable storage medium having stored therein computer software and/or data.

In alternative implementations, secondary memory 1110 may include other similar means for allowing computer programs or other instructions to be loaded into computer system 1100. Such means may include, for example, a removable storage unit 1122 and an interface 1120. Examples of such means may include a program cartridge and cartridge interface (such as that found in video game devices), a removable memory chip (such as an EPROM, or EEPROM) and associated socket, and other removable storage units 1122 and interfaces 1120 which allow software and data to be transferred from the removable storage unit 1122 to computer system 1100. In non-limiting embodiments, one or more of the memories of marketing systems 110 and 310 and their respective tools 112 and tracking system 316 described above with reference to FIGS. 1-3 can be embodied as the main memory 1108 shown in FIG. 11.

Computer system 1100 may also include a communications interface 1124. Communications interface 1124 allows software and data to be transferred between computer system 1100 and external devices. Communications interface 1124 may include a modem, a network interface (such as an Ethernet card), a communications port, a PCMCIA slot and card, or the like. Software and data transferred via communications interface 1124 may be in the form of signals, which may be electronic, electromagnetic, optical, or other signals capable of being received by communications interface 1124. These signals may be provided to communications interface 1124 via a communications path 1126. Communications path 1126 carries signals and may be implemented using wire or cable, fiber optics, a phone line, a cellular phone link, an RF link or other communications channels.

As used herein, the terms “computer readable medium” and “non-transitory computer readable medium” are used to generally refer to media such as memories, such as main memory 1108 and secondary memory 1110, which can be memory semiconductors (e.g., DRAMs, etc.). Computer readable medium and non-transitory computer readable medium can also refer to removable storage unit 1118, removable storage unit 1122, and a hard disk installed in hard disk drive 1112. Signals carried over communications path 1126 can also embody the logic described herein. These computer program products are means for providing software to computer system 1100.

Computer programs (also called computer control logic) are stored in main memory 1108 and/or secondary memory 1110. Computer programs may also be received via communications interface 1124. Such computer programs, when executed, enable computer system 1100 to implement the present invention as discussed herein. In particular, the computer programs, when executed, enable processor device 1104 to implement the processes of the present invention, such as the blocks in method 400 illustrated by the flowchart of FIG. 4, discussed above. Accordingly, such computer programs represent controllers of the computer system 1100. Where the invention is implemented using software, the software may be stored in a computer program product and loaded into computer system 1100 using removable storage drive 1114, interface 1120, and hard disk drive 1112, or communications interface 1124.

In an embodiment, the display devices used to display interfaces and output shown in FIGS. 5-9, may be a computer display 1130 shown in FIG. 11. The computer display 1130 of computer system 1100 can be implemented as a touch sensitive display (e.g., a touch screen). Similarly, the interfaces and analysis results depicted in FIGS. 6-9 may be rendered using the display interface 1102 shown in FIG. 11.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.), and communication mediums (e.g., wired and wireless communications networks, local area networks, wide area networks, intranets, etc.).

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A method for scoring users to facilitate selection of which users will receive electronic marketing communications, the method comprising:
identifying, by a marketing system, a target product for the marketing campaign;
collecting, by a sentiment engine configured to determine sentiments of referral sources, a referral context and a degree of sentiment from a referral source referring a user to a web page associated with the product;
determining time spent by the user on the web page and the user's interactions with the web page; and
assigning a score to the user based at least in part on the time spent by the user on the web page and the user's interactions with the web page.

2. The method of claim 1, further comprising:
in response to determining that the score exceeds a threshold, sending an electronic marketing communication to the user; and
collecting information indicating a relevance between a context of the marketing communication and the user's interactions with the web page, wherein a link for the web page is specified in the marketing communication,
wherein the relevance between the context of the marketing communication and the user's interactions on the web page is determined based on a total time of interactions with content of the web page that is relevant to the product.

3. The method of claim 2, wherein the marketing communication is sent via email, social media, or text message.

4. The method of claim 1, wherein the referral source is a referring web page, and wherein the referral context is determined based at least in part on a number of important keywords that the user has read at the referring web page and a normalized term frequency for the keywords.

5. The method of claim 1, further comprising categorizing the user based at least in part on the score.

6. The method of claim 5, wherein the categorizing comprises:
categorizing the user as a cold lead based on a low score;
categorizing the user as a warm lead based on a medium score; and
categorizing the user as a hot lead based on a high score.

7. The method of claim 1, further comprising:
in response to determining that the total time spent by the user the web page associated with the product is below a threshold, assigning a low score to the user.

8. The method of claim 1, further comprising:
in response to determining that the time spent by the user on the web page associated with the product exceeds a threshold, referring the user to a nurturing program, wherein assigning the score to the user is based at least in part on results of the nurturing program.

9. The method of claim 8, wherein, based on the referral context and the degree of sentiment, the nurturing program specifies one or more product features to emphasize to the user.

10. The method of claim 8, wherein, based on the referral context and the degree of sentiment, the nurturing program:
specifies one or more other target products; and
refers the user to the one or more other target products.

11. A system comprising:
a processing device;
a real-time data tracking system configured to collect data from data sources for use by a marketing system;
a sentiment engine configured to determine sentiments of referral sources and to provide the sentiments to the real-time data tracking system; and
a non-transitory computer-readable medium communicatively coupled to the processing device, wherein the processing device is configured to execute instructions to perform operations comprising;
identifying, by the marketing system, a target product for a marketing campaign;
collecting, by the sentiment engine, a referral context and a degree of sentiment from a referral source referring a user to a web page associated with the product;
determining time spent by the user on the web page and the user's interactions with the web page; and
assigning a score to the user based at least in part on the time spent by the user on the web page and the user's interactions with the web page.

12. The system of claim 11, wherein the referral source is a referring web page, and wherein the referral context is determined based at least in part on a number of important keywords that the user has read at the referring web page and a normalized term frequency for the keywords.

13. The system of claim 11, the operations further comprising:
in response to determining that the score exceeds a threshold, sending a marketing communication to the user; and
collecting information indicating a relevance between a context of the marketing communication and the user's interactions with the web page, wherein a link for the web page is specified in the marketing communication,
wherein the relevance between the context of the marketing communication and the user's interactions on the web page is determined based on a total time of interactions with content of the web page that is relevant to the product.

14. The system of claim 11, the operations further comprising categorizing the user based at least in part on the score, wherein the categorizing comprises:
categorizing the user as a cold lead based on a low score;
categorizing the user as a warm lead based on a medium score; and
categorizing the user as a hot lead based on a high score.

15. The system of claim 11, the operations further comprising:
in response to determining that the time spent by the user on the web page associated with the product exceeds a threshold, referring the user to a nurturing program, wherein assigning the score to the user is based at least in part on results of the nurturing program.

16. The system of claim 15, wherein, based on the referral context and the degree of sentiment, the nurturing program specifies one or more product features to emphasize to the user.

17. The system of claim 15, wherein, based on the referral context and the degree of sentiment, the nurturing program:
specifies one or more other target products; and
refers the user to the one or more other target products.

18. A non-transitory computer-readable medium having program code stored thereon, the program code comprising:
program code for identifying a target product for a marketing campaign;
program code for collecting a referral context and a degree of sentiment from a referral source referring a user to a web page associated with the product;
program code for determining time spent by the user on the web page and the user's interactions with the web page; and
program code for assigning a score to the user based at least in part on the time spent by the user on the web page and the user's interactions with the web page.

19. The non-transitory computer-readable medium of claim 18, the program code further comprising:
in response to determining that the score exceeds a threshold, program code for sending a marketing communication to the user; and
program code for collecting information indicating a relevance between a context of the marketing communication and the user's interactions with the web page, wherein:
a link for the web page is specified in the marketing communication;
the relevance between the context of the marketing communication and the user's interactions on the web page is determined based on a total time of interactions with content of the web page that is relevant to the product; and
the marketing communication is sent via email, social media, or text message.

20. The non-transitory computer-readable medium of claim 18, wherein the referral source is a referring web page, and wherein the referral context is determined based at least in part on a number of important keywords that the user has read at the referring web page and a normalized term frequency for the keywords.
